(19) United States
(12) Patent Application Publication
(10) Pub. No.: US 2025/0002085 A1
(43) Pub. Date: Jan. 2, 2025

(54) STEER-BY-WIRE STEERING ASSEMBLY

(71) Applicant: CHASSIS AUTONOMY SBA AB, Trollhättan (SE)

(72) Inventors: Peter JOHANSSON, Trollhättan (SE); Thomas LI, London (GB)

(73) Assignee: CHASSIS AUTONOMY SBA AB, Trollhättan (SE)

(21) Appl. No.: 18/885,076

(22) Filed: Sep. 13, 2024

Related U.S. Application Data
(63) Continuation-in-part of application No. PCT/SE2023/050310, filed on Apr. 5, 2024.
(63) Continuation-in-part of application No. PCT/SE2023/050313, filed on Apr. 5, 2023.
(63) Continuation-in-part of application No. PCT/SE2023/050314, filed on Apr. 5, 2023.
(63) Continuation-in-part of application No. PCT/SE2023/050315, filed on Apr. 5, 2023.
(63) Continuation-in-part of application No. PCT/SE2023/050309, filed on Apr. 5, 2023.
(63) Continuation-in-part of application No. PCT/SE2023/050308, filed on Apr. 5, 2023.

(30) Foreign Application Priority Data
Apr. 6, 2022 (SE) 2250437-7
Jun. 1, 2022 (SE) 2230175-8
Jun. 1, 2022 (SE) 2230176-6
Jun. 1, 2022 (SE) 2230177-4
Jun. 1, 2022 (SE) 2230178-2
Jun. 1, 2022 (SE) 2230179-0
Jun. 1, 2022 (SE) 2230180-8

(51) Int. Cl. B62D 15/02; B62D 5/04

(52) U.S. Cl. CPC B62D 15/0235; B62D 5/0427; B62D 5/0445; B62D 15/0225

(57) ABSTRACT

A steer-by-wire steering assembly comprises a housing and a motor assembly having at least one rotor and at least one stator having a first motor winding and a second motor winding, the at least one stator being mounted to the housing. A steering shaft comprises a threaded portion configured to engage with a screw actuator and to move longitudinally with respect to the housing when the first motor winding and/or the second motor winding is actuated. A rotational sensor is mounted on the housing adjacent to one or more rotatable components. The rotational sensor is configured to generate a signal in dependence on detecting rotational movement of the rotatable components. A linear displacement sensor is mounted to an end of the steering shaft. The linear displacement sensor is configured to generate a signal in dependence of detecting linear movement of the steering shaft.

### CROSS-REFERENCE TO RELATED APPLICATIONS

This application is a Continuation-in-Part of International Application No. PCT/SE2023/050308, filed Apr. 5, 2023, which claims priority to Swedish Patent Application No. 2250437-7, filed Apr. 6, 2022, and to Swedish Patent Application No. 2230175-8, filed Jun. 1, 2022; is a Continuation-in-Part of International Application No. PCT/SE2023/050309, filed Apr. 5, 2023, which claims priority to Swedish Patent Application No. 2250437-7, filed Apr. 6, 2022, and to Swedish Patent Application No. 2230176-6, filed Jun. 1, 2022; is a Continuation-in-Part of International Application No. PCT/SE2023/050310, filed Apr. 5, 2023, which claims priority to Swedish Patent Application No. 2250437-7, filed Apr. 6, 2022, and to Swedish Patent Application No. 2230177-4, filed Jun. 1, 2022; is a Continuation-in-Part of International Application No. PCT/SE2023/050313, filed Apr. 5, 2023, which claims priority to Swedish Patent Application No. 2250437-7, filed Apr. 6, 2022, and to Swedish Patent Application No. 2230178-2, filed Jun. 1, 2022; is a Continuation-in-Part of International Application No. PCT/SE2023/050314, filed Apr. 5, 2023, which claims priority to Swedish Patent Application No. 2250437-7, filed Apr. 6, 2022, and to Swedish Patent Application No. 2230179-0, filed Jun. 1, 2022; and is a Continuation-in-Part of International Application No. PCT/SE2023/050315, filed Apr. 5, 2023, which claims priority to Swedish Patent Application No. 2250437-7, filed Apr. 6, 2022, and to Swedish Patent Application No. 2230180-8, filed Jun. 1, 2022, the entire contents of each of which are incorporated herein by reference.

### FIELD

The present disclosure relates to a steer-by-wire steering assembly.

### DESCRIPTION OF RELATED ART

The automotive industry is developing technology to increasingly assist users with various driving operations in vehicles including steering. For example, it is known to provide powered steering to assist a user or even control the steering for the user.

As automotive technology develops, there is a trend to attempt to fully automate vehicles so that user input is no longer needed. One aspect of autonomous vehicular control that is needed is autonomous steering. Typically the steering systems required in autonomous vehicles are steer-by-wire steering systems which can be controlled by control signals from a vehicle control unit.

A steer-by-wire system does not necessarily require a mechanical linkage between a user input e.g. a steering wheel and the steering linkage e.g. a rack and pinion steering assembly. Indeed, in some steer-by-wire implementations, no user input is needed because the steer-by-wire system is fully controlled by an autonomous vehicle control unit.

However in the absence of user input, the vehicular systems of the autonomous vehicle need to be robust in order for an autonomous vehicle to be reliable. This may mean that the steer-by-wire systems have multiple redundancies in order to meet industrial safety standards e.g. Automotive Safety Integrity Level (ASIL) C or D ISO 26262.

One such steer-by-wire system is shown in EP 3 819 190 which shows a steer-by-wire actuation system which has two steering motors and two electrical control units controlling the steering motors for controlling rotation of the two steering motors. The two steering motors are connected to a ball screw which interacts with a cooperating ball screw nut mounted on a shaft.

Another steer-by-wire system is shown in U.S. Pat. No. 6,394,218 which discloses a steering system having a steering linkage and two positioners capable of positioning the steering linkage in union. Each positioner comprises a control unit, a servomotor, and a position sensor.

Whilst both EP 3 819 190 and U.S. Pat. No. 6,394,218 disclose steer-by-wire systems with aspects of multiple redundancies, there are parts of each steer-by-wire system which comprise single points of failure. This means that these systems can only be fail-safe in practice. Ultimately, this limits the use cases where these steer-by-wire systems can be implemented especially if a legislative framework requires a robust steer-by-wire system.

In order for a steer-by-wire system to be reliable enough for an autonomous vehicle and associated legal requirements, the steer-by-wire system may need to be fail-operational. This means if the steer-by-wire system incurs a fault, the autonomous vehicle can still function, even if it is at a reduced operational capacity.

### SUMMARY

Examples of the present disclosure aim to address the aforementioned problems.

In a first aspect of the present disclosure there is provided a steer-by-wire steering assembly comprising: a housing; a motor assembly having at least one rotor and at least one stator having a first motor winding and a second motor winding, the at least one stator being mounted to the housing; at least one screw actuator operatively coupled to the at least one rotor; a steering shaft connectable to at least one tie rod, the steering shaft comprising a threaded portion configured to engage with the screw actuator and to move longitudinally with respect to the housing when the first motor winding and/or the second motor winding is actuated; and at least one rotational sensor mounted on the housing adjacent to one or more rotatable components, the at least one rotational sensor being configured to generate a signal in dependence on detecting rotational movement of the rotatable components with respect to the housing; and at least one linear displacement sensor mounted to an end of the steering shaft, the linear displacement sensor being configured to generate a signal in dependence of detecting linear movement of the steering shaft with respect to the housing.

Optionally, the at least one linear displacement sensor is mounted adjacent to the tie rod.

Optionally, the one or more rotatable components is the at least one rotor.

Optionally, the steer-by-wire steering assembly comprises a rotor carrier sleeve rotatably mounted to the housing and coupled between the at least one rotor and the at least one screw actuator.

Optionally, the at least one rotational sensor is a plurality of rotational sensors mounted circumferentially about the housing.

Optionally, the at least one rotational sensor is configured to detect rotational movement of the rotor carrier sleeve with respect to the housing.

Optionally, a reluctor ring is mounted to the rotor carrier sleeve.

Optionally, the at least one rotational sensor is a hall-effect sensor.

Optionally, the at least one linear displacement sensor is one or more of an optical sensor, a linear resistive sensor, linear voltage displacement transducer, linear potentiometer, a potentiometric linear transducer, or a hall-effect sensor.

Optionally, the at least one linear displacement sensor comprises a first linear displacement sensor portion mounted on the steering shaft and a second linear displacement sensor portion mounted to the housing.

Optionally, the second linear displacement sensor portion is a hall-effect sensor mounted to the housing and the first linear displacement sensor portion is a linear tooth pattern mounted to the steering shaft.

Optionally, linear tooth pattern varies as a function of distance along the steering shaft and the hall-effect sensor is configured to vary a generated signal in dependence the position of the hall-effect sensor with respect to the linear tooth pattern.

Optionally, the at least one screw actuator is a roller screw actuator comprising a plurality of planetary roller screws operatively coupled to the at least one rotor.

Optionally, the steer-by-wire steering assembly comprises a first electronic control unit configured to send one or more control signals to the first motor and/or the second motor and a second electronic control unit configured to send one or more control signals to the second motor and/or the first motor.

Optionally, the first electronic control unit and the second electronic control unit are configured to receive one or more control signals from a vehicle control unit.

Optionally, the motor assembly comprises a first motor having a first rotor and a first stator having the first motor winding and a second motor having a second rotor and a second stator having the second motor winding, wherein the first stator and the second stator are mounted to the housing.

According to a second aspect of the present disclosure there is a steer-by-wire steering assembly comprising: a housing; a motor assembly having at least one rotor and at least one stator having a first motor winding and a second motor winding, the at least one stator being mounted to the housing; at least one screw actuator operatively coupled to the at least one rotor; a steering shaft connectable to at least one tie rod, the steering shaft comprising a threaded portion configured to engage with the at least one screw actuator and to move longitudinally with respect to the housing when the first motor winding and/or the second motor winding is actuated; and at least one bearing mounted between the housing and the steering shaft wherein the bearing comprises at least one elongate channel configured to receive a projecting component or portion of the steering shaft.

Optionally, the at least one bearing comprises a C-shaped cross-sectional open profile.

Optionally, the at least one bearing comprises a first bearing element configured to engage a first side of the steering shaft and a second bearing element configured to engage a second side of the steering shaft.

Optionally, the at least one bearing comprises a first channel configured to receive a first projecting component or a first portion of the steering shaft and a second channel configured to receive a second projecting component or a second portion of the steering shaft.

Optionally, the steering shaft is configured to not rotate about a longitudinal axis of the steering shaft with respect to the at least one bearing.

Optionally, the steering shaft comprises an elongate groove slidably engageable with an elongate rib mounted on an inner surface of the at least one bearing.

Optionally, the elongate channel extends in a direction which is parallel with a longitudinal axis of the steering shaft.

Optionally, the elongate channel is an open channel.

Optionally, the steer-by-wire steering assembly comprises a linear displacement sensor having a first sensor portion mounted in the at least one elongate channel on the steering shaft and a second sensor portion mounted to the housing configured to project into the at least one elongate channel.

Optionally, the at least one bearing is mounted at a first end of the housing and the at least one bearing is configured to engage a first end of the steering shaft.

Optionally, the at least one screw actuator is a roller screw actuator comprising a plurality of planetary roller screws operatively coupled to the at least one rotor.

Optionally, the steer-by-wire steering assembly comprises a rotor carrier sleeve rotatably mounted to the housing and coupled between the at least one rotor and the at least one screw actuator.

Optionally, the steering shaft is mounted inside the rotor carrier sleeve.

Optionally, the steer-by-wire steering assembly comprises a first electronic control unit configured to send one or more control signals to the first motor and/or the second motor and a second electronic control unit configured to send one or more control signals to the second motor and/or the first motor.

Optionally, the first electronic control unit and the second electronic control unit are configured to receive one or more control signals from a vehicle control unit.

Optionally, the at least one bearing is a first bearing mounted at a first end of the housing and the first bearing is configured to engage a first end of the steering shaft and a second bearing mounted at a second end of the housing and second bearing is configured to engage a second end of the steering shaft.

Optionally, the motor assembly comprises a first motor having a first rotor and a first stator having the first motor winding and a second motor having a second rotor and a second stator having the second motor winding, wherein the first stator and the second stator are mounted to the housing.

In a third aspect of the present disclosure there is provided a steer-by-wire steering assembly comprising: a housing; a motor assembly having at least one rotor and at least one stator having a first motor winding and a second motor winding, the at least one stator being mounted to the housing; a screw actuator operatively coupled to the at least one rotor; a steering shaft connectable to at least one tie rod, the steering shaft comprising a threaded portion configured to engage with the screw actuator and to move longitudinally with respect to the housing when the first motor winding and/or the second motor winding is actuated; and a linear displacement sensor positioned near an end of the steering shaft, the linear displacement sensor configured to generate a signal in dependence of detecting linear movement of the steering shaft with respect to the housing.

Optionally, the at least one linear displacement sensor is mounted adjacent to the tie rod.

Optionally, the at least one linear displacement sensor is one or more of an optical sensor, a linear resistive sensor, linear voltage displacement transducer, linear potentiometer, a potentiometric linear transducer, or a hall-effect sensor.

Optionally, the at least one linear displacement sensor comprises a first linear displacement sensor portion mounted on the steering shaft and a second linear displacement sensor portion mounted to the housing.

Optionally, the second linear displacement sensor portion is an optical sensor mounted to the housing and the first linear displacement sensor portion are a plurality of reference indicators on the steering shaft.

Optionally, the second linear displacement sensor portion is a hall-effect sensor mounted to the housing and the first linear displacement sensor portion is a linear tooth pattern mounted to the steering shaft.

Optionally, the linear tooth pattern varies as a function of distance along the steering shaft and the hall-effect sensor is configured to vary a generated signal in dependence the position of the hall-effect sensor with respect to the linear tooth pattern.

Optionally, the at least one screw actuator is a roller screw actuator comprising a plurality of planetary roller screws operatively coupled to the at least one rotor.

Optionally, the steer-by-wire steering assembly comprises a rotor carrier sleeve rotatably mounted to the housing and coupled between the at least one rotor and the at least one screw actuator.

Optionally, the steering shaft is mounted inside the rotor carrier sleeve.

Optionally, the steer-by-wire steering assembly comprises a first electronic control unit configured to send one or more control signals to the first motor and/or the second motor and a second electronic control unit configured to send one or more control signals to the second motor and/or the first motor.

Optionally, the first electronic control unit and the second electronic control unit are configured to receive one or more control signals from a vehicle control unit.

Optionally, the motor assembly comprises a first motor having a first rotor and a first stator having the first motor winding and a second motor having a second rotor and a second stator having the second motor winding, wherein the first stator and the second stator are mounted to the housing.

In a fourth aspect of the present disclosure there is provided a steer-by-wire steering assembly comprising: a housing; at least one electronic control unit; a motor assembly having at least one rotor and at least one stator having a first motor winding and a second motor winding, the at least one stator being mounted to the housing and the at least one electronic control unit having at least one data connection with the motor assembly and the at least one electronic control unit is configured to control the first motor winding and the second motor winding; a screw actuator operatively coupled to the at least one rotor; a steering shaft connectable to at least one tie rod, the steering shaft comprising a threaded portion configured to engage with the screw actuator and to move longitudinally with respect to the housing when the first motor winding or the second motor winding is actuated; and a first displacement sensor mounted to the housing configured to send a signal to the at least one electronic control unit in dependence of detecting a centre reference target of the steering shaft; wherein the electronic control unit is configured to determine a displacement of the steering shaft with respect to the housing in dependence of the received signal from the first displacement sensor and rotational information of the at least one rotor.

Optionally, the electronic control unit is configured to reset the determined displacement to zero when the centre reference target is detected.

Optionally, the rotational information is one or more signals received from the motor assembly comprising rotational information of the at least one rotor.

Optionally, the rotational information is one or more signals received from at least one rotational sensor mounted to the housing configured to send a signal in dependence of detecting relative rotational displacement of the at least one rotor with respect to the housing.

Optionally, the rotational information is determined from one or more control signals issued to the motor assembly from the electronic control unit.

Optionally, the electronic control unit is configured to determine the displacement based on the rotational information and a gearing parameter of the screw actuator.

Optionally, the electronic control unit is configured to compare the determined displacement with a signal received from a second displacement sensor.

Optionally, the electronic control unit is configured to issue an alert signal when the electronic control unit determines that the determined displacement deviates from a predetermined tolerance of a second displacement determined from the signal received from a second displacement sensor.

Optionally, a first displacement sensor is a hall-effect sensor.

Optionally, the centre reference target is a centre reference feature on the steering shaft and the first displacement sensor is configured to detect the centre reference feature.

Optionally, the centre reference feature is a notch, recess, raised profile, or projecting tooth on the steering shaft.

Optionally, the centre reference target is a centre reference magnet in the steering shaft and the first displacement sensor is configured to detect the centre reference magnet.

Optionally, a first displacement sensor is an optical sensor configured to detect a reference indicator on the surface of the steering shaft.

Optionally, a first displacement sensor is a mechanical switch configured to detect a raised peg mounted on the surface of the steering shaft.

Optionally, the at least one screw actuator is a roller screw actuator comprising a plurality of planetary roller screws operatively coupled to the at least one rotor.

Optionally, the steer-by-wire steering assembly comprises a rotor carrier sleeve rotatably mounted to the housing and coupled between the at least one first rotor and the at least one screw actuator.

Optionally, the steering shaft is mounted inside the rotor carrier sleeve.

Optionally, the at least one electronic control unit is configured to receive one or more control signals from a vehicle control unit.

Optionally, the motor assembly comprises a first motor having a first rotor and a first stator having the first motor winding and a second motor having a second rotor and a second stator having the second motor winding, wherein the first stator and the second stator are mounted to the housing.

In a fifth aspect of the present disclosure there is provided a method of controlling a steer-by-wire steering assembly having a housing; at least one electronic control unit; a motor assembly having at least one rotor and at least one stator having a first motor winding and second motor winding, the at least one stator being mounted to the housing and the at least one electronic control having at least one data connection with the motor assembly and the at least one electronic control is configured to control the first motor winding and the second motor winding; a screw actuator operatively coupled to the at least one rotor; a steering shaft connectable to at least one tie rod, the steering shaft comprising a threaded portion configured to engage with the screw actuator and to move longitudinally with respect to the housing when the first motor winding or the second motor winding is actuated; the method comprising: detecting a centre reference target of the steering shaft with a first displacement sensor mounted to the housing; sending signal from a first displacement sensor mounted to the housing to the at least one electronic control unit; determining a displacement of the steering shaft with respect to the housing in dependence of the received signal from the first displacement sensor and rotational information of the at least one rotor.

In a sixth aspect of the present disclosure there is provided a steer-by-wire steering assembly comprising: a housing; a motor assembly having at least one rotor and at least one stator having a first motor winding and a second motor winding, the at least one stator being mounted to the housing; a screw actuator operatively coupled to the at least one rotor; a steering shaft connectable to at least one tie rod, the steering shaft comprising a threaded portion configured to engage with the screw actuator and move longitudinally with respect to the housing when the first motor winding and/or the second motor winding is actuated and an end reference target adjacent to a first end of the steering shaft; and at least one steering shaft end proximity sensor mounted to a first side of the housing, the steering shaft end proximity sensor being configured to generate a signal in dependence of detecting the end reference target when the first end of the steering shaft moves towards or away from the first side of the housing.

Optionally, the steering shaft end proximity sensor is a hall-effect sensor, an optical sensor, or a microswitch.

Optionally, the end reference target is an end reference feature in the steering shaft.

Optionally, the end reference target is a notch, recess, raised profile, or projecting tooth on the steering shaft.

Optionally, the steering shaft end proximity sensor is configured to detect a surface of a tie rod coupling mounted to an end of the steering shaft.

Optionally, the steering shaft end proximity sensor is configured to detect a centre reference target corresponding to a centre alignment position of the steering shaft.

Optionally, the steering shaft end proximity sensor is configured to detect the centre reference target and the end reference target wherein the centre reference target and the end reference target have a different shape.

Optionally, the steering shaft end proximity sensor is configured to generate a first signal in dependence of detecting the end reference target and a second signal in dependence of detecting the centre reference target.

Optionally, the steering shaft end proximity sensor is configured to detect a first end reference target corresponding to a first end of the steering shaft and a second end reference target corresponding to a second end of the steering shaft.

Optionally, the steer-by-wire steering assembly comprises a first steering shaft end proximity sensor mounted to a first side of the housing configured to detect a first end reference target corresponding to a first end of the steering shaft and second steering shaft end proximity sensor mounted to a second side of the housing configured to detect a second end reference target corresponding to a second end of the steering shaft.

Optionally, the at least one screw actuator is a roller screw actuator comprising a plurality of planetary roller screws operatively coupled to the at least one rotor.

Optionally, the steer-by-wire steering assembly comprises a rotor carrier sleeve rotatably mounted to the housing and coupled between the at least one rotor and the at least one screw actuator.

Optionally, the steering shaft is mounted inside the rotor carrier sleeve.

Optionally, the steer-by-wire steering assembly comprises a first electronic control unit configured to send one or more control signals to the first motor and/or the second motor and a second electronic control unit configured to send one or more control signals to the second motor and/or the first motor.

Optionally, the first electronic control unit and the second electronic control unit are configured to receive one or more control signals from a vehicle control unit.

Optionally, the motor assembly comprises a first motor having a first rotor and a first stator having the first motor winding and a second motor having a second rotor and a second stator having the second motor winding, wherein the first stator and the second stator are mounted to the housing.

In a seventh aspect of the present disclosure there is provided a steer-by-wire steering assembly comprising: a housing; a motor assembly having at least one rotor and at least one stator having a first motor winding and a second motor winding, the at least one stator being mounted to the housing; a screw actuator operatively coupled to the at least one rotor; a steering shaft connectable to at least one tie rod, the steering shaft comprising a threaded portion configured to engage with the screw actuator and to move longitudinally with respect to the housing when the first motor winding and/or the second motor winding is actuated; and at least one sensor mounted to the housing, the sensor configured to detect movement of one or more components of the steer-by-wire steering assembly with respect to the housing; and an electromagnetic field (EMF) shield mounted on the housing between the at least one sensor and the first and second motor windings wherein the electromagnetic field shield is configured to attenuate electromagnetic field generated by the first and second motor windings.

Optionally, the EMF shield comprises at least one intermediate wall of the housing positioned between the at least one sensor and the first and second motor windings.

Optionally, the intermediate wall comprises a recess for receiving an EMF attenuating material.

Optionally, the EMF shield comprises one or more layers of an EMF attenuating material mounted to the housing.

Optionally, the EMF attenuating material is one or more of a wire mesh material, an EMF shielding fabric, metal foam, a metal screen, a metal sheet.

Optionally, the EMF shield comprises one or more components of the steer-by-wire steering assembly.

Optionally, the one or more components comprises the screw actuator.

Optionally, the EMF shield comprises a wire mesh envelope configured to surround the at least one sensor.

Optionally, the at least one sensor is a hall-effect sensor, an inductive sensor, an optical sensor, or a microswitch sensor.

Optionally, the inductive sensor is configured to detect relative rotation of a target ring fixed with respect to the at least one rotor.

Optionally, the at least one screw actuator is a roller screw actuator comprising a plurality of planetary roller screws operatively coupled to the at least one rotor.

Optionally, the steer-by-wire steering assembly comprises a rotor carrier sleeve rotatably mounted to the housing and coupled between the at least one rotor and the at least one screw actuator.

Optionally, the steering shaft is mounted inside the rotor carrier sleeve.

Optionally, the steer-by-wire steering assembly comprises a first electronic control unit configured to send one or more control signals to the first motor and/or the second motor and a second electronic control unit configured to send one or more control signals to the second motor winding and/or the first motor winding.

Optionally, the first electronic control unit and the second electronic control unit are configured to receive one or more control signals from a vehicle control unit.

Optionally, the motor assembly comprises a first motor having a first rotor and a first stator having the first motor winding and a second motor having a second rotor and a second stator having the second motor winding, wherein the first stator and the second stator are mounted to the housing.

In an eighth aspect of the present disclosure there is provided a steer-by-wire steering assembly comprising: a housing; a first motor having a first rotor and a first stator and a second motor having a second rotor and a second stator, the first stator and the second stator being mounted to the housing; a first electronic control unit configured to send one or more control signals to the first motor and/or the second motor; a second electronic control unit configured to send one or more control signals to the second motor and/or the first motor; a roller screw actuator comprising a plurality of planetary roller screws operatively coupled to the first rotor and the second rotor; and a steering shaft connectable to a first tie rod at a first shaft end and a second tie rod at a second shaft end, the steering shaft comprising a threaded portion configured to engage with the plurality of roller screws and to move longitudinally with respect to the housing when the first motor and/or the second motor is actuated; a linear displacement sensor positioned near the first shaft end, the linear displacement sensor configured to generate a signal in dependence of detecting linear movement of the first shaft end of the steering shaft with respect to the housing; a rotational displacement sensor mounted on the housing, the rotational displacement sensor configured to generate a signal in dependence of detecting rotational movement of a rotor carrier sleeve coupled between the first rotor, the second rotor and the roller screw actuator; and at least one steering shaft end proximity sensor configured to generate a signal in dependence of detecting an end reference position on the steering shaft when the second shaft end of the steering shaft moves towards or away from the housing; wherein the first electronic control unit and/or the second electronic control unit is configured to determine position information of the steering shaft from each of the signals generated from the linear displacement sensor, the rotational displacement sensor, and the steering shaft end proximity sensor.

Optionally, the first electronic control unit and/or the second electronic control unit is configured to determine position information of the steering shaft independently from each of the signals generated from the linear displacement sensor, the rotational displacement sensor, and the steering shaft end proximity sensor.

Optionally, the first electronic control unit and/or the second electronic control unit are configured to issue operational control instructions when one of the linear displacement sensor, the rotational displacement sensor, and the steering shaft end proximity sensor fails.

Optionally, the first electronic control unit and/or the second electronic control unit are configured issue an alert indicating a fail-operational status when one of the linear displacement sensor, the rotational displacement sensor and the steering shaft end proximity sensor fails.

Optionally, the steer-by-wire steering assembly is fault tolerant.

Optionally, the steer-by-wire steering assembly is fail-operational.

Optionally, the first electronic control unit and the second electronic control unit are configured to receive one or more control signals from a vehicle control unit

Optionally, the steer-by-wire steering assembly comprises a rotor carrier sleeve rotatably mounted to the housing and coupled between the first rotor, the second rotor, and the at least one screw actuator.

Optionally, the steering shaft is mounted inside the rotor carrier sleeve.

### BRIEF DESCRIPTION OF THE DRAWINGS

Various other aspects and further examples are also described in the following detailed description and in the attached claims with reference to the accompanying drawings, in which:

FIG. 1 shows a perspective view of a steering assembly according to an example;

FIG. 2 shows a cross-sectional side view of a steering assembly according to an example;

FIG. 3 shows a partial perspective view of a steering assembly according to an example;

FIG. 4 shows a cross-sectional side view of part of a steering assembly according to an example;

FIG. 5 shows another partial perspective view of a steering assembly according to an example;

FIG. 6 shows a plan view of a steering assembly according to an example;

FIG. 7 shows a side view of a steering assembly according to an example;

FIG. 8 shows a perspective view of part of a steering assembly according to an example;

FIGS. 9a, 9b, 9c and 9d show cross-sectional views of part of a steering assembly according to an example;

FIG. 10 shows a perspective view of some components of a steering assembly according to an example;

FIG. 11 shows a perspective view of a steering assembly according to an example;

FIG. 12 shows a cross-sectional side view of a steering assembly according to an example;

FIG. 13 shows a partial side cross-sectional view of the steering assembly according to an example;

FIG. 14 shows a cross-sectional side view of part of a steering assembly according to an example;

FIG. 15 shows a cross-sectional side view of part of a steering assembly according to an example;

FIG. 16 shows a schematic representation of the steering assembly according to an example;

FIG. 17 shows a flow diagram of operation of the steering assembly according to an example; and

FIG. 18 shows a close up side cross-sectional view of the steering assembly according to an example.

### DETAILED DESCRIPTION

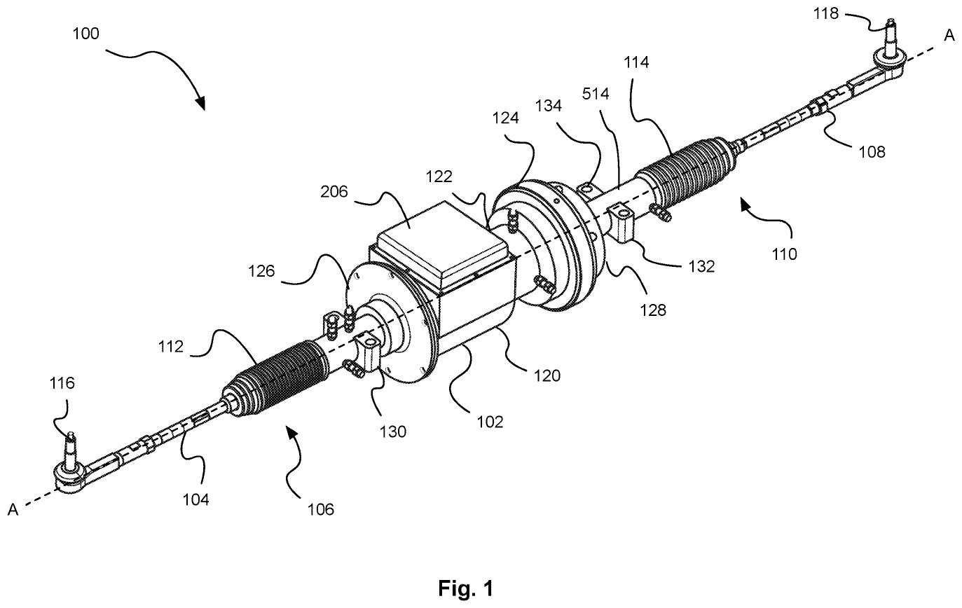

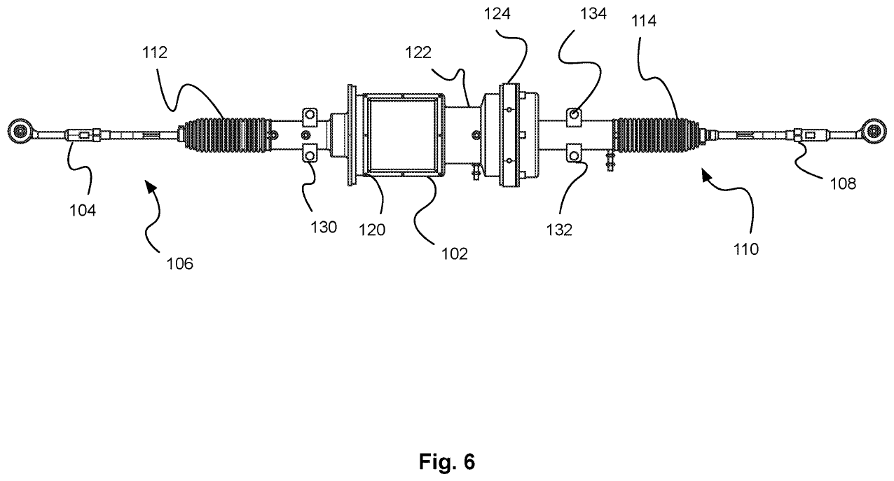

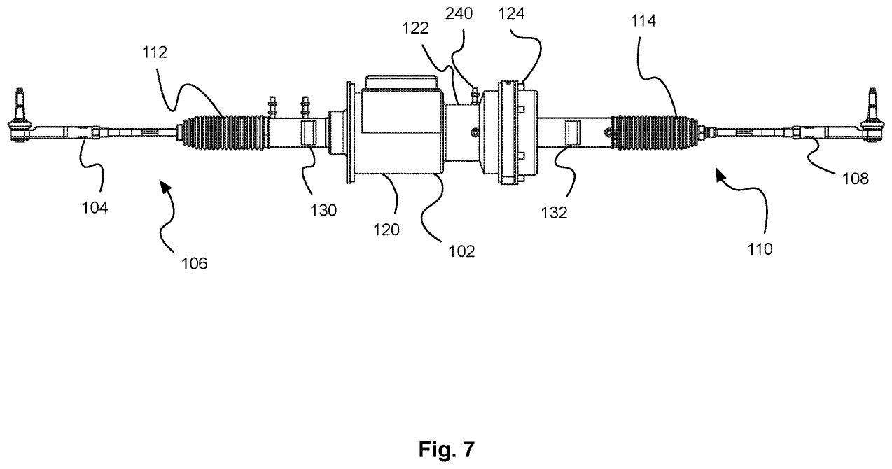

FIG. 1 shows a perspective view of a steering assembly 100. FIGS. 6 and 7 show a side and plan view of thew steering assembly 100. The steering assembly 100 comprises a main housing 102 and one or more components of the steering assembly 100 are mounted within the main housing 102. The steering assembly 100 is generally elongate in construction and extends along a longitudinal axis A-A. As discussed below, one or more components of the steering assembly 100 are aligned along the longitudinal axis A-A.

The steering assembly 100 as shown in FIG. 1 is coupled to a first tie rod 104 at a first steering assembly end 106 of the steering assembly 100. The steering assembly 100 is also coupled to a second tie rod 108 at a second steering assembly end 110 of the steering assembly 100.

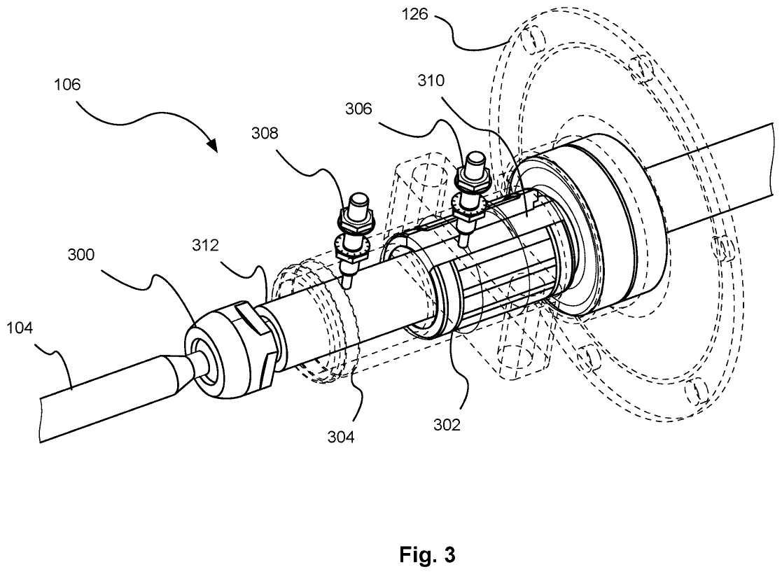

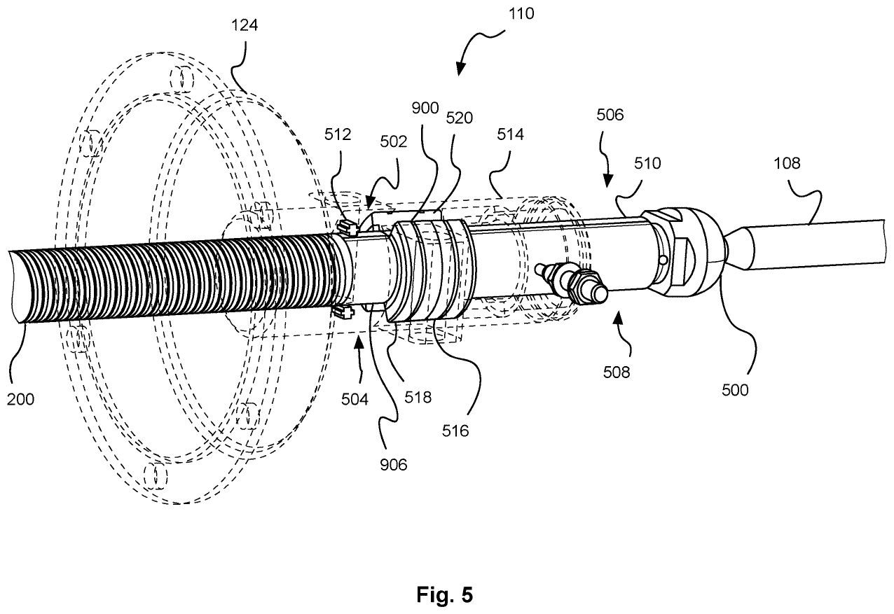

The steering assembly 100 is coupled to the first tie rod 104 with a first tie rod coupling 300 (best shown in FIG. 3.). FIG. 3 shows a partial perspective view of the steering assembly 100 at the first steering assembly end 106. The steering assembly 100 is also coupled to the second tie rod 108 with a second tie rod coupling 500 (best shown in FIG. 5). FIG. 5 shows a partial perspective view of the steering assembly 100 at the second steering assembly end 110. In some examples, both the first tie rod coupling 300 and the second tie rod coupling 500 are ball joints.

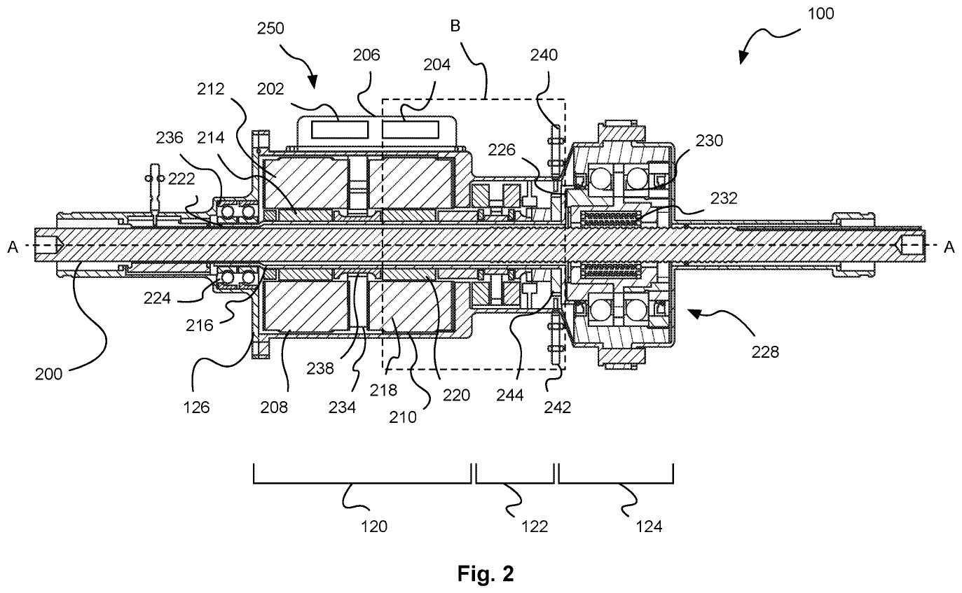

The steering assembly 100 comprises a steering shaft 200 (best shown in FIG. 2.) FIG. 2 shows a side cross-sectional view of the steering assembly 100. The steering shaft 200 is configured to move in a linear direction along the longitudinal axis A-A with respect to the main housing 102. In some examples, the longitudinal axis of the steering shaft 200 is aligned with the longitudinal axis A-A of the steering assembly 100 e.g. coaxial with the longitudinal axis A-A of the steering assembly 100. In some other examples, the longitudinal axis of the steering shaft 200 extends in a direction parallel to the longitudinal axis A-A of the steering assembly 100.

The steering shaft 200 is not visible in FIG. 1 because a first bellow sleeve 112 and a second bellow sleeve 114 extend over and cover the steering shaft 200 respectively at the first steering assembly end 106 and the second steering assembly end 110. The first bellow sleeve 112 and the second bellow sleeve 114 protect the steering shaft 200 and the first and second tie rod couplings 300, 500 from dirt and debris. The first and second bellow sleeves 112, 114 are mounted to the main housing 102 and permit relative movement of the first and second tie rods 104, 108 with respect to the main housing 102 whilst maintaining a seal against the main housing 102 and the first and second tie rods 104, 108.

The first and second tie rods 104, 108 are respectively connected to a first tie rod end 116 and a second tie rod end 118. The first and second tie rod ends 116, 118 are configured to be respectively pivotally connected to a first and second steering knuckle, for example this may be a ball-joint (not shown). The tie rods and steering knuckles are known and will not be discussed in any further detail.

As shown in FIG. 1, in some examples, the main housing 102 comprises a plurality of different housing portions with differing diameters. The different housing portions in some examples are separate elements and mountable to each other. This may make assembly during manufacturing easier. For example an ECU housing 206 is mounted to the main housing 102.

The main housing 102 as shown in FIGS. 1 and 2 comprises a motor housing portion 120, a sensor housing portion 122 and a screw actuator housing portion 124. The motor housing portion 120 is connected to the sensor housing portion 122 and the sensor housing portion 122 is connected between the motor housing portion 120 and the screw actuator housing portion 124.

In some examples, the motor housing portion 120, the sensor housing portion 122 and the screw actuator housing portion 124 are a single unitary element. For example, the motor housing portion 120, the sensor housing portion 122 and the screw actuator housing portion 124 are cast or manufactured as a single component. In some other examples, the motor housing portion 120, the sensor housing portion 122 and the screw actuator housing portion 124 are separate housing elements and each of the motor housing portion 120, the sensor housing portion 122 and the screw actuator housing portion 124 are fastened together with e.g. bolts, welds, or any other suitable fastening means.

In some examples, the main housing 102 comprises a first housing cap 126 connected to the motor housing portion 120 and a second housing cap 128 connected to the screw actuator housing portion 124. The first housing cap 126 and the second housing cap 128 in some examples are connected to the main housing 102 via bolts or other screw fasteners. Preferably, the first housing cap 126 and the second housing cap 128 are removable from the main housing 102. This means that the components of the steering assembly 100 are accessible if needed during maintenance of the steering assembly 100.

The main housing 102 is mountable to a vehicle structure (not shown) e.g. a chassis via a first and second mounting connection 130, 132 The first and second mounting connections 130, 132 comprise fastener holes 134 configured to receive screw fasteners such as bolts. For the purposes of clarity a single fastener hole 134 has been labelled in FIG. 1. However, each of the first and second mounting connections 130, 132 has two or more fastener holes 134. In this way the first and second mounting connections 130, 132 ensure that the steering assembly 100 is fixed to the vehicle structure. The first and second mounting connections 130, 132 as shown in FIG. 1 are an exemplary arrangement and the position of the first and second mounting connections 130, 132 with respect to the main housing 102 can be modified depending on the form, size and shape of vehicle structure and the mounting locations on the vehicle structure. In some examples, there are preferably three or more mounting connections 130, 132 such that the steering assembly 100 is fixed in a plane with respect to the vehicle structure.

In some examples, the vehicle is an electric vehicle e.g. an electric car or electric truck. In some other examples, the vehicle is a vehicle with an internal combustion engine or any other type of motorised vehicle. The steering assembly 100 as discussed in reference to the accompanying Figs can be used with any suitable vehicle with at least one steerable wheel.

In some examples, the steering assembly 100 is a steer-by-wire steering assembly 100. The term steer-by-wire means that there is no mechanical linkage between a user input e.g. a steering wheel (not shown) or control input device and the steering assembly 100. For example, the steering assembly 100 does not comprise a steering wheel connected to a rack and pinion mechanism (not shown).

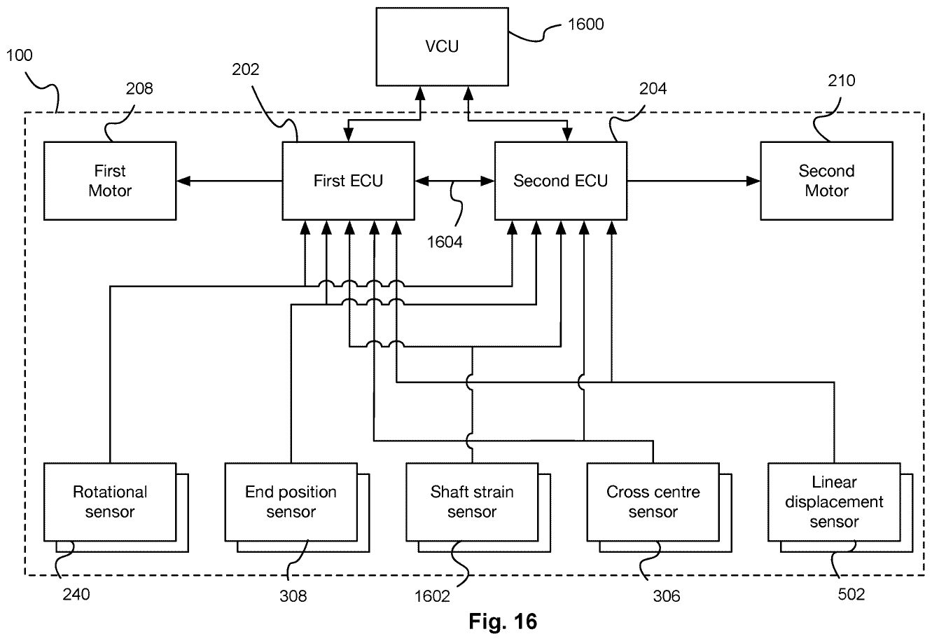

Instead, control instructions are provided from one or more electronic control units (ECU) 202, 204 configured to control the steering assembly 100. As mentioned above, the first and second ECUs 202, 204 are mounted in an ECU housing 206. The ECU housing 206 is mounted to the main housing 102. In some other examples, the ECU housing 206 is mounted in a separate location to the steering assembly 100 or remote from the main housing 102 connected by data and power connections to the steering assembly 100 as shown in the Figs. The first and second ECUs 202, 204 optionally receive control instructions from a vehicle control unit (VCU) 1600 (best shown in FIG. 16). Data connections to and from the first and second ECUs 202, 204 have not been shown in the Figures for the purposes of clarity. In some less preferred examples, the steering assembly 100 is optionally configured to receive control instructions directly from the VCU 1600 and there are no ECUs 202, 204.

Hereinafter reference to the steer-by-wire steering assembly 100 will be made using the term “steering assembly 100”.

In some examples, the steering assembly 100 is controlled in response to control instructions from a user input e.g. an electrically connected steering wheel.

Alternatively other user input devices can be used with the steering assembly 100 e.g. a joystick, or any other suitable user input control device.

Additionally or alternatively, the steering assembly 100 is controlled from control instructions received from the first or second ECUs 202, 204 or the VCU 1600. For example, the steering assembly 100 is optionally a subassembly of an autonomous vehicle. However, even if the steering assembly 100 is used in an autonomous vehicle, it may be preferable to allow control of the steer-by-wire steering assembly 100 from a user input device e.g. an electrically connected steering wheel. This will permit user controlled testing and review of the steering assembly 100 in an autonomous vehicle on the roads.

Turning to FIG. 2, the steering assembly 100 will be discussed in more detail.

The steering assembly 100 comprises a motor assembly 250 having first motor 208 and a second motor 210. The first motor 208 and the second motor 210 are mounted within the motor housing portion 120. In some examples, the first motor 208 is controlled by the first ECU 202 and the second motor 210 is controlled by the second ECU 204. Additionally or alternatively, either the first motor 208 and/or the second motor 210 is configured to receive control instructions from any of the first or second ECUs 202, 204 or the VCU 1600. Reference hereinafter to the control of the steering assembly 100 is made in reference to the first ECU 202 and the second ECU 204 issuing control instructions to the first motor 208 and the second motor 210. The first ECU 202 is configured to issue control instructions to either the first motor 208 and/or the second motor 210. Similarly, the second ECU 204 is configured to issue control instructions to either the first motor 208 and/or the second motor 210. The first ECU 202 and the second ECU 204 can operate independently of each other or alternatively together in unison. This means that control functionality discussed in the present disclosure with respect to the first ECU 202 is applicable to the second ECU 204 as well.

In some preferred examples, the first ECU 202 is configured to control the first motor 208 and the second ECU 204 is configured to control the second motor 210. The first and second ECUs 202, 204 are connected with an ECU data connection 1604 (best shown in FIG. 16) and are configured to communicate an operational status to each other via the ECU data connection 1604. The first and second ECUs 202, 204 are configured to transmit and receive fault states to either the other ECUs 202, 204 and/or the VCU 1600. In this way, the first ECU 202 can determine whether there is a fault state with the second ECU 204 or the second motor 210 from system status messages sent from the second ECU 204. Similarly, the second ECU 204 can determine whether there is a fault state with the first ECU 202 or the first motor 208 from system status messages sent from the first ECU 202.

In the event that e.g. the second ECU 204 or the second motor 210 experiences a fault or malfunction, the second ECU 204 either sends a system status message comprising a fault indication to the first ECU 202 or no system status message is sent. On receipt of the system status message comprising a fault indication or the first ECU 202 determining that no system status message has been received, the first ECU determines that there is a fault or malfunction with the second ECU 204 or the second motor 210. Accordingly, the first ECU 202 assumes total control of the steering assembly 100 and the first ECU 202 issues control instructions to the first motor 208. In this way, the first ECU 202 and the first motor 208 can still operate the steering assembly 100 when either the second ECU 204 or the second motor 210 have failed. The second ECU 204 comprises a similar functionality to the first ECU 202 and is configured to assume total control of the steering assembly 100 if the second ECU 204 determines that either the first ECU 202 or the first motor 208 has failed.

The first motor 208 comprises a first stator 212 and a first rotor 214. The term “motor” means a set of motor windings mounted in a stator which a configured to rotate at least one rotor when energised. The first stator 212 comprises one or more motor windings configured to cause the first rotor 214 to rotate when energised. The first rotor 214 is mounted on a rotor carrier sleeve 216 and the rotor carrier sleeve 216 is configured to rotate when the first rotor 214 rotates. The first rotor 214 is fixed with respect to the rotor carrier sleeve 216. In some examples the first rotor 214 is press-fit onto the rotor carrier sleeve 216. In some alternative examples, a tolerance ring (not shown) is used instead of a press-fit. A tolerance ring may be beneficial because a tolerance ring is easier to install with less force and this reduces the risk of surface damage to the rotor carrier sleeve 216 when assembled.

The second motor 210 comprises a second stator 218 and a second rotor 220. The second stator 218 comprises one or more motor windings configured to cause the second rotor 220 to rotate when energised. The second rotor 220 is also mounted on the rotor carrier sleeve 216 and the rotor carrier sleeve 216 is configured to rotate when the second rotor 220 rotates. The second rotor 220 is also fixed with respect to the rotor carrier sleeve 216. In some examples, similarly the second rotor 220 is press-fit onto the rotor carrier sleeve 216.

In some other examples, the motor assembly 250 comprises only a first stator 212 which comprises a first set of motor windings and a second set of motor windings. The first stator 212 with first and second sets of motor windings is configured to rotate the first rotor 214 when either the first or second sets of motor windings are energised. In this example, there is only a single first rotor 214. Indeed, either the first set of motor windings or the second set of motor windings is configured to rotate the first rotor 214 when energised. In this example, the first motor 208 can be considered to be a combination of the first stator 212 with the first set of motor windings and the first rotor 214. The second motor 210 can be considered to be a combination of the first stator 212 with the second set of motor windings and the first rotor 214.

In another example, the motor assembly 250 comprises a first stator 212 which comprises a first set of motor windings and a second set of motor windings in combination with the first rotor 214 and the second rotor 220. The first stator 212 with first set of motor windings is configured to rotate the first rotor 214 when energised. The first stator 212 with second set of motor windings is configured to rotate the second rotor 202 when energised. In this example, the first motor 208 can be considered to be a combination of the first stator 212 with the first set of motor windings and the first rotor 214. The second motor 210 can be considered to be a combination of the first stator 212 with the second set of motor windings and the second rotor 220.

The first and second motors 208, 210 in other examples can have any suitable number of sets of motor windings e.g. two, three, four etc sets of motor windings with multiple phases e.g. 3 or 6 phases.

It should be noted that the previously discussed variations in the motor assembly 250 and the first and second motors 208, 210 and the arrangement of the first and second stators 212, 218 and the first and second rotors 214, 220 are applicable to any of the examples discussed in reference to the Figures.

The first and second motors 208, 210 in some examples are induction motors. In some other examples the first and second motors 208, 210 are any other suitable type of electric motor e.g. a brushless DC electric motor (BLDC), synchronous motor, 3 phase induction motor etc.

The preferred examples as shown in the FIG. 2 will now be discussed in more detail. That is, the first motor 208 comprising the first stator 212 and the first rotor 214 and the second motor 210 comprising the second stator 218 and the second rotor 220.

In this way, either the second motor 210 or the first motor 208 are configured to cause rotation of the rotor carrier sleeve 216. Accordingly, the second motor 210 or the first motor 208 are configured to provide a torque and rotational speed to the rotor carrier sleeve 216. For example, if one of the first motor 208 or the second motor 210 develops a fault, the other of the first motor 208 or the second motor 210 can still rotate the rotor carrier sleeve 216. A “fault” means anything relating to operation of the ECU, sensors, or motor. For example, the second ECU 204, the second motor 210 or one or more sensors develops a fault. The part of the steering assembly 100 comprising the second ECU 204 and the second motor 210 then shuts down and the first ECU 202 is configured to provide functionality by issuing control instructions to the first motor 208. This means that the steering assembly 100 is operational even if one of the first or second motor 208, 210 is not operational. Accordingly, this provides fail-operational redundancy.

Whilst FIG. 2 shows a first motor 208 and a second motor 210 in the steering assembly 100, in other examples there can be any suitable number of motors mounted within the motor housing portion 120. Furthermore, as previously mentioned there can be multiple motor windings. This means in some examples there can be one physical motor but multiple separate electrical motor circuits providing separate motor functionality. For example, there can be three motors, four motors etc. The first and second motors 208, 210 as shown in FIG. 2 are adjacent to each other within the motor housing portion 120. A stator spacer 234 is mounted on the steering shaft 200 to ensure that the first motor 208 and the second motor 210 do not interfere with each other when actuated.

In some examples the first stator 212 and the second stator 218 are press-fit into the motor housing portion 120. The stator spacer 234 is also press-fit between the first stator 212 and the second stator 218 to ensure separation between the first stator 212 and the second stator 218. The press-fit provides an interference fit between the first stator 212 and the second stator 218 and the motor housing portion 120. This means that friction between the first stator 212, the second stator 218 and the motor housing portion 120 ensures that the first stator 212, the second stator 218 and the motor housing portion 120 are fixed with respect to each other.

As mentioned above, in some examples the first rotor 214 and the second rotor 220 are press-fit onto the rotor carrier sleeve 216. First and second rotors 214, 220 are separated on the rotor carrier sleeve 216 via a rotor spacer 238. The rotor spacer 238 is also press-fit on the rotor carrier sleeve 216 between the first rotor 214 and the second rotor 220 to ensure separation between the first rotor 214 and the second rotor 220.

The term “press-fit” used to describe the accompanying Figs provides connection between two components having an interference fit. This means that the connection between the two components generates sufficient frictional force that the two components are fixed with respect to each other. However, in some other examples, any other suitable means can be used for fixing two components with respect to each other e.g. a tolerance ring, welding, adhesive, bonding, bolting, interlocking features etc.

The rotor carrier sleeve 216 is an elongate tube which extends along the longitudinal axis A-A. The rotor carrier sleeve 216 is rotatable about the steering shaft 200. The rotor carrier sleeve 216 is coaxial with the steering shaft 200. A first sleeve end 222 of the rotor carrier sleeve 216 is rotatably mounted to the main housing 102 via a rotor carrier sleeve bearing 224. In some examples, the rotor carrier sleeve bearing 224 is press-fit onto the rotor carrier sleeve 216 and the rotor carrier sleeve bearing 224 is press-fit into a reciprocal bearing recess 236 in the first housing cap 126.

A second sleeve end 226 of the rotor carrier sleeve 216 is connected to a screw actuator 228. The screw actuator 228 is mounted in the screw actuator housing portion 124. Similar to the rotor carrier sleeve bearing 224, the screw actuator 228 is press-fit into the screw actuator housing portion 124.

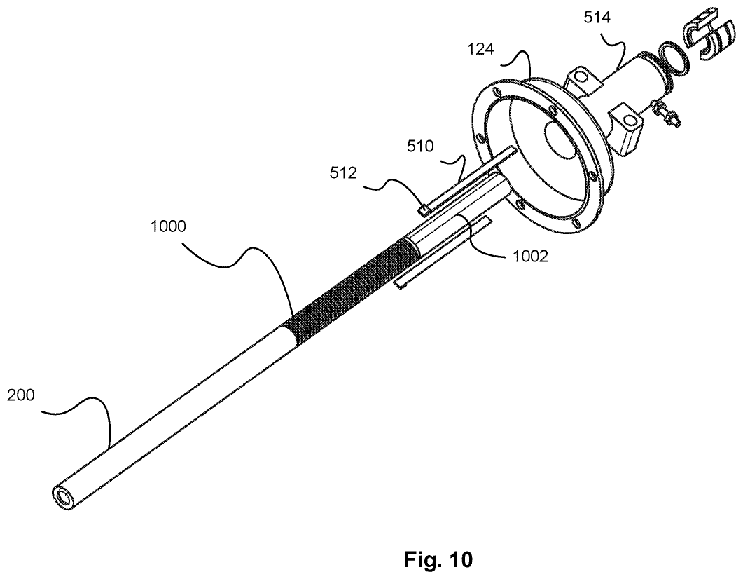

The screw actuator 228 is configured to engage with a threaded portion 1000 (best shown in FIG. 10) on the steering shaft 200. FIG. 10 shows an exploded perspective view of some of the components of the steering assembly 100 at the second steering assembly end 110.

When the screw actuator 228 rotates, the screw actuator 228 is configured to cause a linear displacement of the steering shaft 200 along the longitudinal axis A-A. Depending on the direction of rotation of the screw actuator 228, the steering shaft 200 moves in a direction towards the first steering assembly end 106 or a direction towards the second steering assembly end 110. Accordingly, the torque, direction, and speed that the first and/or second motor 208, 210 rotate determines the speed, direction, and magnitude of the linear displacement of the steering shaft 200.

As shown in FIG. 2 the screw actuator 228 is in some examples a planetary roller screw 230. In some other examples, the screw actuator 228 is a ball screw bearing (not shown) configured to engage the threaded portion 1000. In some other examples, the screw actuator 228 is any suitable rotating mechanism configured to engage one or more parts of the groove of the threaded portion 1000 whilst rotating. In FIG. 2 there is an integrated roller screw 230 with a rotating nut and bearing. However in some other examples, there can be a separate roller screw and nut which is pressed into a bearing.

The roller screw 230 as shown in FIG. 2 comprises a plurality of planetary rollers 232. For the purposes of clarity, only one planetary roller 232 has been labelled in FIG. 2. The roller screw 230 can comprise four, six, or eight planetary rollers 232 or any other number of planetary rollers 232 as required. In some examples, six planetary rollers 232 is preferable since it provides accuracy in the linear displacement of the steering shaft 200 but does not reduce the efficiency of the steering assembly 100 too much by increasing the friction between the screw actuator 228 and the threaded portion 1000 of the steering shaft 200.

Each of the planetary rollers 232 is in physical engagement with the threaded portion 1000 of the steering shaft 200. An advantage of the roller screw 230 is that the planetary rollers 232 better engage the threaded portion 1000 than e.g. a ball screw. For example, the planetary rollers 232 are each configured to engage the threaded portion 1000 with no linear or limited play in the direction of the longitudinal axis A-A. In other words, the steering shaft 200 does not move with respect to the planetary rollers 232 in a direction along the longitudinal axis A-A when the planetary rollers 232 are not rotating about the steering shaft 200. This means the tolerance of the rotational movement and consequently the linear movement of the steering shaft 200 is much higher. Ball screws are limited by the ball size to transfer load. The smaller the ball, the smaller the pitch and finer ratio between motor rotation and linear travel of the shaft. This means that ball screws provide a physical limitation in respect of the minimum possible linear movement e.g. 1 to 5 ratio e.g. one revolution results in 5 mm of linear movement in the steering shaft 200. In contrast, the roller screw 230 can provide a finer linear movement. The roller screw 230 provides a better load capacity and durability and in some examples the roller screw 230 provides a smaller minimum possible linear e.g. 1 to 4 or 1 to 3 ratio e.g. one revolution results in 4 mm or 3 mm of linear movement in the steering shaft 200.

The roller screw 230 advantageously simultaneously engages an elongate portion of the threaded portion 1000. This means that the steering shaft 200 is better held in position along the longitudinal axis A-A.

In order for the first and second ECUs 202, 204 to determine the status of one or more components of the steering assembly 100, the steering assembly 100 comprises a plurality of sensors connected to the first and second ECUs 202, 204. The plurality of sensors each are configured to generate and send a signal which the first and/or second ECUs 202, 204 determine the linear displacement of the steering shaft 200 with respect to the main housing 102.

The different sensor arrangements in the steering assembly 100 which provide sensor redundancy and allow a fail-operational arrangement will now be discussed.

### Rotational Sensor

In some examples sensor housing portion 122 comprises at least one rotational sensor 240 configured to detect relative rotational motion of the rotor carrier sleeve 216 with respect to the main housing 102 or the sensor housing portion 122.

As shown in FIG. 2 there is a first rotational sensor 240 and a second rotational sensor 242 configured to detect rotational movement of the rotor carrier sleeve 216. In some alternative examples, the first rotational sensor 240 and the second rotational sensor 242 are mounted to detect rotational movement of one or more of the other rotating components e.g. the first or second rotors 214, 220. However, detecting the rotational movement of the rotor carrier sleeve 216 is advantageous because the first rotational sensor 240 and a second rotational sensor 242 do not need to be immediately adjacent to the first or second motors 208, 210. This means that the first and second motors 208, 210 and the overall steering assembly 100 can be more compact.

In some other examples, the at least one rotational sensor 240 is the first rotational sensor 240, the second rotational sensor 242, and a third rotational sensor (not shown). The first rotational sensor 240, the second rotational sensor 242, and the third rotational sensor are circumferentially spaced around the sensor housing portion 122 at 120 degree angles. In some other examples, there can be more rotational sensors mounted to the sensor housing portion 122 circumferentially spaced around the sensor housing portion 122 e.g. four, six, eight etc rotational sensors.

In some examples, the first rotational sensor 240, the second rotational sensor 242, and the third rotational sensor are configured to detect rotational movement of a reluctor ring 244 mounted to the rotor carrier sleeve 216. The reluctor ring 244 comprises a plurality of circumferential notches or teeth and the first rotational sensor 240, the second rotational sensor 242, and the third rotational sensor are configured to detect relative movement of a notch of the reluctor ring 244. In some examples, the first rotational sensor 240, the second rotational sensor 242, and the third rotational sensor are hall-effect sensors.

The angular spacing of the first rotational sensor 240, the second rotational sensor 242, and the third rotational sensor is dependent on the number of teeth in the reluctor ring 244. In some examples, the angular spacing of the first rotational sensor 240, the second rotational sensor 242, and a third rotational sensor is arranged such that the first rotational sensor 240, the second rotational sensor 242, and the third rotational sensor are configured such that there is a phase difference between the sensing of each sensor on the teeth.

The reluctor ring 244 in some examples comprises a plurality of identical teeth equally spaced circumferentially around the reluctor ring 244. In some other examples, the reluctor ring 244 may comprise unequally spaced circumferentially around the reluctor ring 244 or alternatively asymmetric teeth on the reluctor ring 244. This means that the signal generated by the first rotational sensor 240, the second rotational sensor 242, and the third rotational sensor is dependent on the direction of movement of the teeth. In this way, the first or second ECU 202, 204 is configured to determine the speed of rotational movement, the magnitude of the rotational displacement and the direction of the rotational movement.

In some examples, the first rotational sensor 240, the second rotational sensor 242, and/or the third rotational sensor are hall-effect sensors which are configured to detect variations in the rotor carrier sleeve 216. That is, the reluctor ring is optional and the outer surface of the rotor carrier sleeve 216 comprises one or more features detectable by the the first rotational sensor 240, the second rotational sensor 242, and/or the third rotational sensor.

Since the the first rotational sensor 240, the second rotational sensor 242, and/or the third rotational sensor are configured to detect relative rotational movement of the rotor carrier sleeve 216, the at least one rotational sensor 240 is not mounted inside the motor housing portion 120. This means that that the at least one rotational sensor 240 can be positioned at a distance from the motors 208, 210. Accordingly, the the at least one rotational sensor 240 is better shielded from the EMF generated by the first and second motors 208, 210.

In some other examples there is only the first rotational sensor 240 configured to detect rotational movement.

Alternatively, the at least one rotational sensor 240 is any other suitable sensor configured to detect relative movement of the rotor carrier sleeve 216 with respect to the main housing 102. For example, the at least one rotational sensor 240 is an optical sensor configured to detect markings on the rotor carrier sleeve 216. In some other examples the at least one rotational sensor 240 is an inductive sensor (not shown) comprising a rotational target (not shown) mounted to the rotor carrier sleeve 216. The inductive sensor is configured to generate an EMF e.g. an Eddie current when the rotational target moves past a coil in the inductive sensor.

In another example, the reluctor ring 244 is replaced with a plurality of magnets (not shown). The plurality of magnets are circumferentially spaced around the rotor carrier sleeve 216. The rotational sensors 240, 242 are configured to detect the rotation of the magnets when the rotator carrier sleeve 216 rotates.

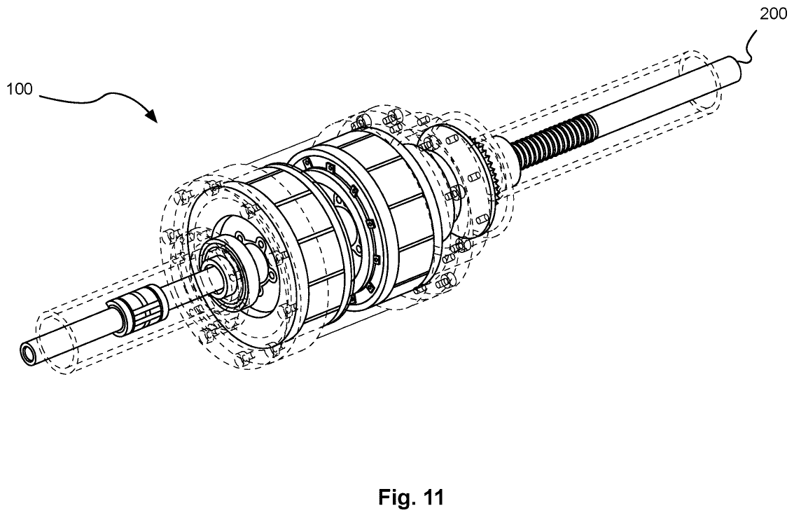

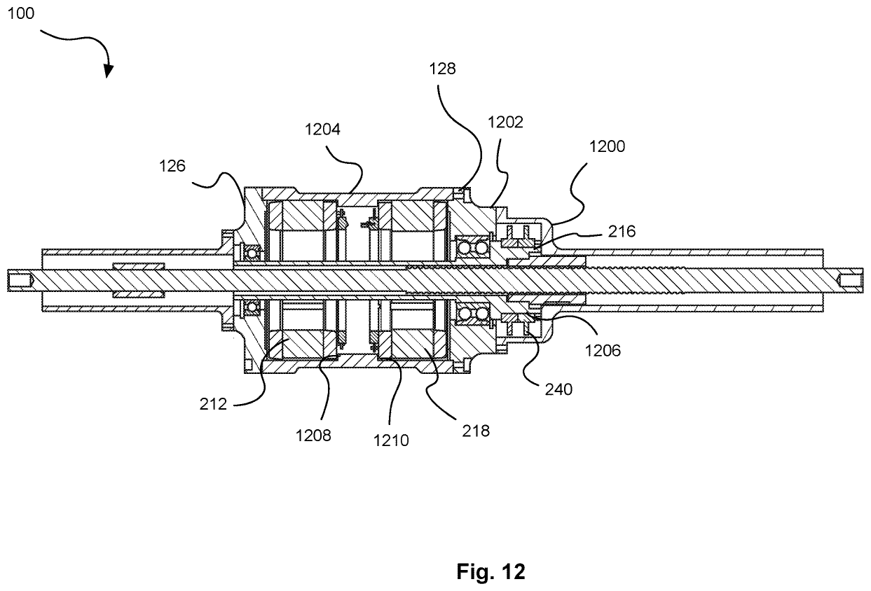

Another example is shown in FIGS. 11 and 12. FIG. 11 shows a perspective view of the steering assembly 100. FIG. 12 shows a side cross-sectional view of the steering assembly 100 in another configuration. In some other examples as shown in FIG. 12, the screw actuator housing portion 1202 is mounted between the sensor housing portion 1200 and the motor housing portion 1204. This means that the at least one rotational sensor 240 detects rotational movement of an end 1206 of the rotor carrier sleeve 216. This is compared to the arrangement shown in FIG. 2 whereby the at least one rotational sensor 240 detects rotational movement in the middle of the rotor carrier sleeve 216. Since the rotor carrier sleeve 216 is a rigid tube, the at least one rotational sensor 240 can precisely measure the rotational movement of the rotor carrier sleeve 216 when mounted adjacent to any part of the rotor carrier sleeve 216.

FIG. 12 shows an alternative arrangement which separates the first stator 212 and the second stator 218. The arrangement ins FIG. 12 does not require a stator spacer 234.

Instead the motor housing portion 1204 comprises a first motor housing shoulder 1208 and a second motor housing shoulder 1210. The first stator 212 engages the first motor housing shoulder 1208 and the second stator 218 engages the second motor housing shoulder 1210. The first mounting cap 126 is fixed to the motor housing portion 1204 and urges the first stator 212 against the first motor housing shoulder 1208. This keeps the first stator 212 in position and fixed with respect to the motor housing portion 1204. The second mounting cap 128 is fixed to the motor housing portion 1204 and urges the second stator 218 against the second motor housing shoulder 1210. This keeps the second stator 212 in position and fixed with respect to the motor housing portion 1204. Accordingly, the first motor housing shoulder 1208 and the second motor housing shoulder 1210 space the first stator 212 and the second stator 218 apart from each other and ensure that the first motor 208 and the second motor 210 do not interfere with each other when actuated.

The steering assembly 100 comprises additional sensors for providing the first ECU 202 and the second ECU 204 with additional status information of different components in the steering assembly 100. In particular, by providing multiple different types of sensors at different positions in the steering assembly 100, multiple redundancy and the capability to perform plausibility checks with respect to the different sensors can be achieved whilst eliminating single points of failure. Accordingly, the sensor signals received by the first or second ECUs 202, 204 are more reliable and trustworthy. When the sensor signals are more plausible, it means that the signals received by first or second ECUs 202, 204 are more likely to be correct. The first or second ECUs 202, 204 in some examples can be configured to determine plausibility of the sensor signals by comparing sensor signals from different sensors or configured to use another data source to validate a part of the sensor signal. Accordingly, the first and second ECU 202, 204 can determine the status of the steering assembly 100 via multiple different independent ways.

### Linear Displacement Sensor

One such additional sensor will now be discussed in reference to FIG. 5 and FIG. 10. FIG. 5 shows a partial perspective view of the steering assembly 100 at a second steering assembly end 110 of steering shaft 200.

FIG. 5 shows the main housing 102 and the screw actuator housing portion 124 with dotted lines for the purposes of clearing showing components e.g. the steering shaft 200 within the main housing 102. A second housing sleeve portion 514 is connected to the screw actuator housing portion 124. The second housing sleeve portion 514 is a cylindrical portion of the main housing 102 that projects from the screw actuator housing portion 124 towards the second steering assembly end 110. The second housing sleeve portion 514 is coaxial with the longitudinal axis A-A. The second housing sleeve portion 514 is configured to protect internal components of the steering assembly 100 including the steering shaft 200. Although not shown in FIG. 5, the second bellow sleeve 114 is mounted to the second housing sleeve portion 514.

In some examples the steering assembly 100 comprises at least one linear displacement sensor 502 mounted on the steering shaft 200. The at least one linear displacement sensor 502 is configured to detect relative linear movement of the steering shaft 200 in a direction along the longitudinal axis A-A with respect to the main housing 102. In some examples, the at least one linear displacement sensor 502 is configured to continuously detect the linear displacement of the steering shaft 200 through the entire possible range of movement of the steering shaft 200. This means that the first or second ECU 202, 204 are configured to constantly determine the absolute linear displacement of the steering shaft 200 from the signal received from the at least one linear displacement sensor 502.

In some examples, as shown in FIG. 5, a first linear displacement sensor 502 is mounted adjacent to the second tie rod 108. In some examples, the first linear displacement sensor 502 is mounted on the steering shaft 200 adjacent to the second tie rod coupling 500. By mounting the first linear displacement sensor 502 adjacent to the second tie rod coupling 500, the linear displacement is detected as close as possible to the second tie rod 108 that couples to the wheel (not shown). This means that the linear displacement is detected as close as possible to the linearly moving elements e.g. the second tie rod 108 and the associated wheel. This means that the sensor signal received from the first linear displacement sensor 502 is more accurate and more trustworthy.

Previously in known steering systems, a rack and pinion system has been used to connect the steering gear to an intermediate shaft and then to a steering control device. In order to measure the linear movement of the rack, a rotary sensor was coupled to the pinion or even a secondary pinion. The measured rotation of the pinion used to determine the linear movement of the steering rack in either direction. However, in the steering assembly 100 discussed herein, there is no need for a mechanical connection between the steering gear and a steering control device. This means that there is correspondingly no need for a rack and pinion interface and no opportunity to measure the rotation of the pinion. Accordingly, providing the first linear displacement sensor 502 provides an alternative solution for measuring the absolute linear displacement of the steering shaft 200 in the absence of a mechanical connection between e.g. the steering control device and the steering rack. Over time the pinon may become worn and therefore determining the linear displacement from a worn pinion introduces measurement errors.

Without a human driver it is of critical importance for the steer-by-wire steering assembly 100 to be able to accurately detect the position of the steering shaft 200 at all times. The linear displacement sensor 502 meets this requirement. Advantageously, the linear displacement sensor 502 is additionally not susceptible to measurement errors due to worn intermediary parts.

In some examples, the first linear displacement sensor 502 comprises a first linear displacement sensor portion 510 and a second linear displacement sensor portion 512. In some examples one of the first linear displacement sensor portion 510 and a second linear displacement sensor portion 512 is a linear sensor component configured to generate a displacement signal and send the displacement signal to the first or the second ECU 202, 204.

The other of the first linear displacement sensor portion 510 and a second linear displacement sensor portion 512 is an elongate sensor target 510.

The linear sensor component 512 is configured to detect movement of the elongate sensor target 510 with respect to the linear sensor component 512. As shown in FIGS. 5 and 10, the first linear displacement sensor portion 510 is the elongate sensor target 510 mounted on the steering shaft 200 and the second linear displacement sensor portion 512 is the linear sensor component 512 e.g. a non-contact inductive sensor mounted to the main housing 102 configured to detect movement of the elongate sensor target 510.

In some examples, the elongate sensor target 510 is mounted on the flat shaft surface 1002 of the steering shaft 200. The linear sensor component 512 is mounted to the second housing sleeve portion 514 as shown in FIG. 5 and the linear sensor component 512 is fixed with respect to the main housing 102. The linear sensor component 512 is configured to detect relative movement of the elongate sensor target 510 with respect to the linear sensor component 512 e.g. when the steering shaft 200 moves along the longitudinal axis A-A.

FIG. 5 shows the linear sensor component 512 mounted to the second housing sleeve portion 514 and the elongate sensor target 510 mounted on the steering shaft 200. However other examples, the linear sensor component 512 is mounted on the steering shaft 200 and the elongate sensor target 510 is mounted on the second housing sleeve portion 514. In this example the elongate sensor target 510 remains fixed with respect the housing 102 and the housing sleeve portion 514 and linear sensor component 512 moves with the steering shaft 200. In some examples, the linear sensor component 512 is fastened to the steering shaft 200. The linear sensor component 512 is received in the elongate channel 900. Optionally, the linear sensor component 512 prevents rotational movement of the steering shaft 200 about the longitudinal axis A-A. This is because the elongate channel 900 and the linear sensor component 512 slidably mounted therein restricts the movement of the steering shaft 200.

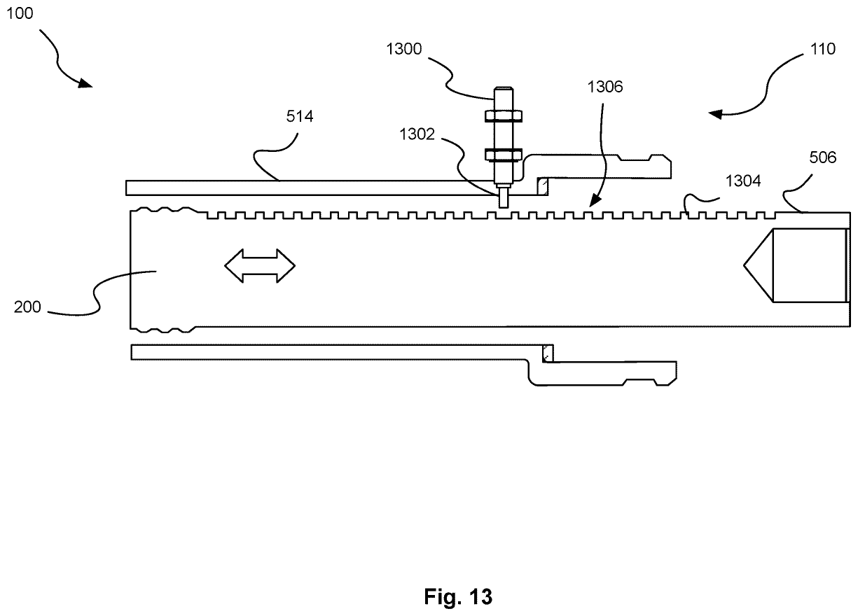

The linear sensor component 512 in some examples is a non-contact inductive sensor and the elongate sensor target 510 are a plurality notches in the steering shaft 200 or magnets mounted on the steering shaft 200. The plurality of notches in the steering shaft 200 will be discussed in more detail below with reference to FIG. 13.

Turning back to FIG. 5, alternatively, the linear sensor component 512 shown is an inductive sensor and the elongate sensor target 510 comprises a sensor target comprising a plurality of inductive loops

In other examples, the linear sensor component 512 is an optical sensor and the elongate sensor target 510 are a series of contrasting markings indications on the steering shaft 200.

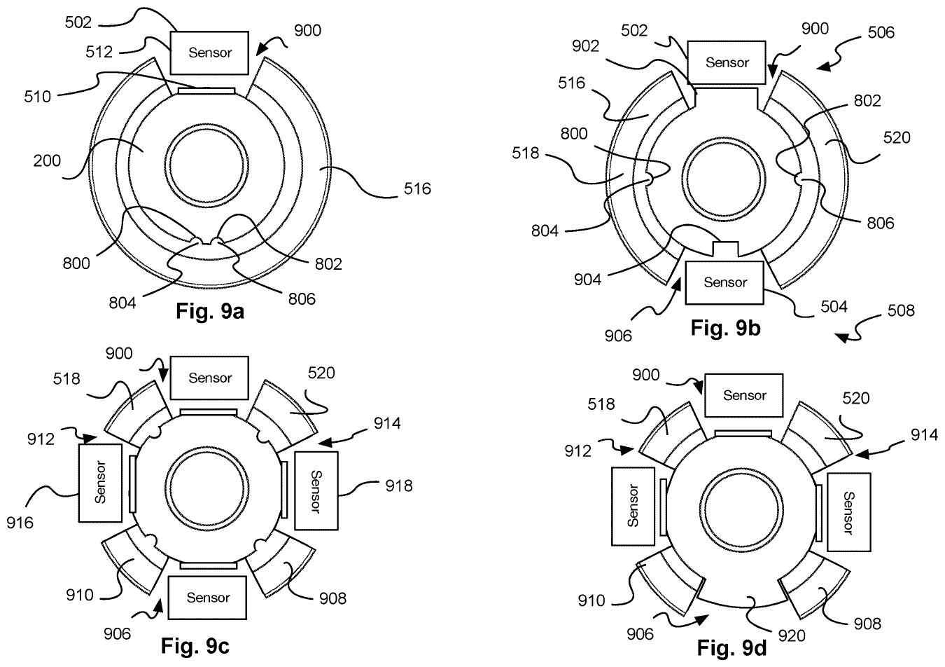

In some examples, the steering assembly 100 optionally comprises a second linear displacement sensor 504. In some examples, the first linear displacement sensor 502 is mounted on a first side 506 of the steering shaft 200 and the second linear displacement sensor 504 is mounted on a second side 508 of the steering shaft 200. As shown in FIG. 5, the first and second linear displacement sensors 502, 504 are mounted on diametric opposite sides of the steering shaft 200. FIG. 9b also shows this arrangement of the first and second linear displacement sensors 502, 504.

The first and second sides 506, 508 of the steering shaft 200 may comprise a flat shaft surface 1002 for mounting the elongate sensor target 510. FIG. 10 best shows the flat shaft surface 1002 for mounting the first linear displacement sensor 502 on.

By providing a first linear displacement sensor 502 and a second linear displacement sensor 504, additional sensor redundancy is provided to the steering assembly 100.

Furthermore, the first and second ECUs 202, 204 can detect whether the steering shaft 200 is moving in a direction parallel to the longitudinal axis A-A. If the first or second ECU 202, 204 detects a difference between the sensor signals sent by the first and second linear displacement sensors 502, 504 this may indicate a fault with the steering assembly 100.

In some examples, the first and second linear displacement sensors 502, 504 are one or more of an optical sensor, a linear resistive sensor, a linear hall-effect sensor, linear voltage displacement transducer, linear potentiometer, a potentiometric linear transducer, or a hall-effect sensor.

Advantageously, the linear displacement sensors 502, 504 measures the absolute position of the steering shaft 200 at all times without the need for a secondary input or reference position. This means that the first and second linear displacement sensors 502, 504 provide accurate functionality regardless of the power cycling of the vehicle electrical system and or data loss

Another example of a linear displacement sensor 1300 is shown in FIG. 13. FIG. 13 shows a partial side cross-sectional view of the steering assembly 100 at the second steering assembly end 110. The linear displacement sensor 1300 comprises a hall-effect sensor 1302 mounted on the second housing sleeve portion 514. The linear displacement sensor 1300 is configured to detect a plurality of reference notches 1304 on the first side 506 of the steering shaft 200. The plurality of reference notches 1304 forms a linear toothed pattern 1306 in the first side 506 of the steering shaft 200. As each reference notch 1304 passes the hall-effect sensor 1302, the hall-effect sensor 1302 is configured to generate a signal and send the signal to the first or second ECU 202, 204. In some examples, the hall-effect sensor 1302 is configured to vary a generated signal in dependence the position of the hall-effect sensor 1302 with respect to the linear tooth pattern 1306. For example, the spacing and size of the notches may vary along the length of the linear tooth pattern 1306. Each reference notch 1304 may comprise a different size and a different spacing from its adjacent reference notches 1304. This means that the linear displacement sensor 1300 is configured to generate a unique displacement signal in dependence of the steering shaft 200 position with respect to the main housing 102. Accordingly, this means that in some examples the first or second ECU 202, 204 is able to determine the position of steering shaft 200 from the linear displacement sensor 1300 with no other information. In some examples, the first or second ECUs 202, 204 are configured to determine that the difference in the spacing and size of the notches in the linear tooth pattern 1306 from the received sensor signal with an additional speed signal. The speed signal can be determined from the at least one rotational sensor 240 to determine the rotor carrier sleeve 216 position.

### Rotational Sensor and Linear Displacement Sensor Placement

By providing both at least one linear displacement sensor 502 and the at least one rotational sensor 240 which are connected to the first and/or the second ECUs 202, 204, additionally the redundancy in the steering assembly 100 is increased. This is because the displacement of the steering shaft 200 can be determined using different methods, and different components. For example, if the at least one linear displacement sensor 502 or the at least one rotational sensor 240 fails, the displacement of the steering shaft 200 can still be determined.

As can be seen in FIG. 2, the at least one rotational sensor 240 is positioned adjacent to the rotor carrier sleeve 216. This means that the rotational movement of the rotating components of the steering assembly 100 is measured as close as possible to the rotating elements e.g. the rotating carrier sleeve 216.

At the same time, FIG. 5 shows the at least one linear displacement sensor 502 positioned adjacent to the second tie rod coupling 500 on the steering shaft 200. This means that the linear movement is measured as close as possible to the linearly moving elements e.g. the first and second tie rods 104, 108 and the wheels.

This means that the combination of the locations of the at least one linear displacement sensor 502 and the at least one rotational sensor 240 provide more accurate measured sensor data which is more trustworthy/reliable.

### Bearing with Elongate Channel

As mentioned above, the steering shaft 200 is configured to move in a linear direction along the longitudinal axis A-A. In order to keep the longitudinal axis of the steering shaft 200 aligned coaxially with the longitudinal axis A-A, the steering shaft 200 is mounted to the main housing 102 with a first steering shaft bearing 302 (best shown in FIG. 3) and a second steering shaft bearing 516 (best shown in FIG. 5). The roller screw 230 also helps keep the steering shaft 200 aligned with the longitudinal axis A-A.

The second steering shaft bearing 516 is mounted to the second housing sleeve portion 514. The second steering shaft bearing 516 is fixed with respect to the second housing sleeve portion 514.

The first steering shaft bearing 302 is mounted to a first housing sleeve portion 304. The first steering shaft bearing 302 is fixed with respect to the first housing sleeve portion 304. The first housing sleeve portion 304 is similar to the previously discussed second housing sleeve portion 514.

The first housing sleeve portion 304 is connected to the motor housing portion 120 or alternatively the first housing cap 126 (as shown in FIG. 3). The first housing sleeve portion 304 is a cylindrical portion of the main housing 102 that projects from the motor housing portion 120 towards the first steering assembly end 106. The first housing sleeve portion 304 is coaxial with the longitudinal axis A-A. The first housing sleeve portion 304 is configured to protect internal components of the steering assembly 100 including the steering shaft 200.

In some examples as shown in FIGS. 3 and 5, the first steering shaft bearing 302 and the second steering shaft bearing 516 are linear bearings. That is, the first steering shaft bearing 302 and the second steering shaft bearing 516 are elongated and are configured to permit movement of the steering shaft 200 with respect to the main housing 102 in a direction along the longitudinal axis A-A. In other examples, the first steering shaft bearing 302 and the second steering shaft bearing 516 can be any other suitable type of bearing to permit longitudinal movement of the steering shaft 200.

In order to best maintain the alignment of the steering shaft 200 along the longitudinal axis A-A, the first steering shaft bearing 302 and the second steering shaft bearing 516 are mounted proximal to the ends of the main housing 102 respectively at the first steering assembly end 106 and the second steering assembly end 110. However, it is preferable to determine displacement information of the steering shaft 200 as close as possible to the first or second tie rod couplings 300, 500. This means in some circumstances a bearing element that completely surrounds the steering shaft 200 will interfere with sensors.

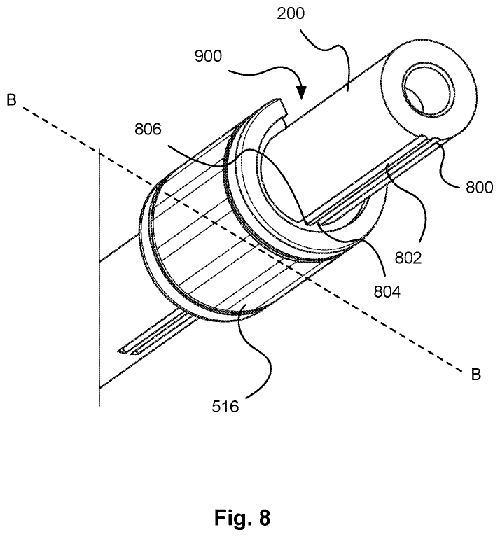

Reference will now be made to FIGS. 3, 5, 8, 9a, 9b, 9c, and 9d to discuss the first and second steering shaft bearings 302, 516. FIG. 8 shows a perspective view of part of the steering shaft 200 and the second steering shaft bearing 516. FIG. 9a shows a cross-sectional view of the steering shaft 200 and the second steering shaft bearing 516 along the axis B-B which is perpendicular to axis A-A. FIGS. 9b, 9c, 9d shows cross-sectional views of other examples of the steering shaft 200 and the second steering shaft bearing 516.

Discussion will now be made to FIGS. 8, 9a, 9b,9c and 9d of the second steering shaft bearing 516. However, the same features of the second steering shaft bearing 516 in some examples are used in the first steering shaft bearing 302 as well.

In some examples, the second steering shaft bearing 516 comprises at least one elongate channel 900 configured to receive a projecting component or portion of the steering shaft 200. As can be seen from FIGS. 8 and 9a, the second steering shaft bearing 516 comprises a C-shaped cross-sectional profile. FIG. 9a shows the second steering shaft bearing 516 having a unitary cross-sectional profile.

The at least one elongate channel 900 extends in a direction which is parallel with the longitudinal axis A-A of the steering shaft 200. The first elongate channel 900 in some examples is an open channel. This makes mounting a component such as the first linear displacement sensor 502 to project into the first elongate channel 900 and detect e.g. the elongate sensor target 510 more easily. In some alternative less preferred examples, the first elongate channel 900 is a closed channel or a bore in the second steering shaft bearing 516. In this way, the closed channel provides a space within the second steering shaft bearing 516, but the closed channel is not as easily accessible.

By providing the first elongate channel 900 in the second steering shaft bearing 516, part of the steering shaft 200 is accessible when the steering assembly 100 is in use.

This means that the first elongate channel 900 in the second steering shaft bearing 516 can be used for determining the status e.g. the position of the steering shaft 200 with respect to the main housing 102.

In this way, the first elongate channel 900 is configured to receive the first linear displacement sensor 502 or part of the first linear displacement sensor 502. As shown in FIG. 5, the first elongate channel 900 is configured to receive the second linear displacement sensor portion 512 e.g. the linear sensor component 512 which projects into the first elongate channel 900. The first linear displacement sensor portion 510 e.g. the elongate sensor target 510 is mounted on the steering shaft 200 within the first elongate channel 900 and is configured to move past the second linear displacement sensor portion 512. This means that the steering shaft 200 can move and the second steering shaft bearing 516 does not touch the second linear displacement sensor portion 512 projecting into the first elongate channel 900.

Alternatively, in some other examples, optionally the second steering shaft bearing 516 comprises a plurality of bearing elements e.g. as shown in FIG. 5, 9b, 9c or 9d.

FIGS. 5 and 9b show the second steering shaft bearing 516 comprising a first bearing element 518 configured to engage a first steering assembly end 106 of the steering shaft 200 and a second bearing element 520 configured to engage a second steering assembly end 110 of the steering shaft 200.

Providing the second steering shaft bearing 516 with the first bearing element 518 and the second bearing element 520 can make assembly of the steering assembly 100 easier. The first bearing element 518 and the second bearing element 520 when assembled can be configured to engage each other and form the C-shaped cross-sectional profile as shown in FIG. 9.

Alternatively, when the first bearing element 518 and the second bearing element 520 are assembled, the first bearing element 518 and the second bearing element 520 do not touch and a first elongate channel 900 and a second elongate channel 906 are formed. In this case, the first elongate channel 900 and/or the second elongate channel 906 are configured to receive the first and second linear displacement sensors 502, 504. This means that a plurality of second linear displacement sensors 502, 504 can be mounted adjacent to the steering shaft 200 in a compact arrangement. Reference has been made to FIGS. 5 and 9b that the first and second linear displacement sensors 502, 504 are identical.

However, in some examples the first and second linear displacement sensors 502, 504 can be different types of linear displacement sensor 502. For example, the first linear displacement sensor 502 and be a combination of hall-effect sensor and a plurality of raised metal elements in the steering shaft 200 and the second linear displacement sensor 504 can be a combination of an optical sensor and a plurality of reference indications on the steering shaft 200.

FIG. 9b shows that the first linear displacement sensor 502 projects into the first elongate channel 900. The first linear displacement sensor 502 is positioned adjacent to the first linear displacement sensor target 902. In some examples, the first linear displacement sensor target 902 is a raised shaft element projecting into the first elongate channel 900 from the steering shaft 200. The first linear displacement sensor target 902 is a metallic element or magnetic element which is fixed to the steering shaft 200. The first linear displacement sensor target 902 can be integral with the steering shaft 200 e.g. the raised shaft element is machined or cast in place. Alternatively, the first linear displacement sensor target 902 can be a separate element welded, adhered, bonded etc to the steering shaft 200.

FIG. 9b also shows that the second linear displacement sensor 504 projects into the second elongate channel 906. The second linear displacement sensor 504 is positioned adjacent to the second linear displacement sensor target 904. In some examples, the second linear displacement sensor target 904 is a recessed portion of the steering shaft 200 in the second elongate channel 906.

The second linear displacement sensor target 904 is a recess in the steering shaft 200 or magnetic element recessed into the steering shaft 200 and which is fixed to the steering shaft 200. Similarly, the second linear displacement sensor target 904 can be integral with the steering shaft 200 e.g. the recess in the steering shaft 200 is machined or cast in place. Alternatively, the second linear displacement sensor target 904 can be a separate magnetic element welded, adhered, bonded etc to the recess in the steering shaft 200.

FIG. 9b shows only a single first linear displacement sensor target 902 and a single second linear displacement sensor target 904. However, a plurality of first linear displacement sensor targets 902 and a plurality of second linear displacement sensor targets 904 are positioned along the steering shaft 200 in the first and second elongate channels 900, 906. An example arrangement of a plurality of sensor targets is shown FIG. 13.

FIG. 9b shows the second steering shaft bearing 516 comprising a first bearing element 518 and a second bearing element 520. This provides a first elongate channel 900 and a second elongate channel 906.

In some alternative examples there can be more bearing elements which provide more elongate channels e.g. third and fourth elongate channels 912, 914. For example FIG. 9c and FIG. 9d show the second steering shaft bearing 516 comprising a first bearing element 518, a second bearing element 520, a third bearing element 908, and a fourth bearing element 910. This provides a first, second, third and fourth elongate channel 900, 906, 912, 914. The additional third and fourth elongate channel 912, 914 mean that additional sensors 916, 918 can be compactly positioned near the steering shaft 200. In some examples, the additional sensors 916, 918 are additional linear displacement sensors but alternatively, they can be other types of sensor e.g. a steering shaft strain sensor 1602 (best shown in FIG. 16).

The first steering shaft bearing 302 is similar in construction to the second steering shaft bearing 516 as shown in FIG. 3. Instead, a cross centre sensor 306 is configured to project into the elongate channel 310 of the first steering shaft bearing 302. The cross centre sensor 306 will be discussed in more detail below.

In some examples, the steering shaft 200 is optionally configured to not rotate about the longitudinal axis A-A of the steering shaft 200 with respect to the second steering shaft bearing 516.

As shown in FIG. 8, in some examples, the steering shaft 200 optionally comprises elongate grooves 800, 802 slidably engageable with elongate ribs 804, 806 mounted on an inner surface of the second steering shaft bearing 516. As shown in FIG. 8, the steering shaft 100 comprises a plurality of elongate grooves 800, 802 and specifically in FIG. 8, a first elongate groove 800 and a second elongate groove 802. The first elongate groove 800 and the second elongate groove 802 are configured to respectively engage reciprocal first and second elongate ribs 804, 806. As shown in FIG. 8, the first and second elongate grooves 800, 802 are positioned diametrically opposite the first elongate channel 900 when the second steering shaft bearing 516 is mounted on the steering shaft 200.

In some alternative examples, not shown in the Figs, the inner surface of the second steering shaft bearing 516 comprises at least one elongate groove 800, 802 slidably engageable with at least one elongate rib 804, 806 mounted on the steering shaft 200.

FIGS. 9b, 9c, 9d show different arrangements whereby the steering shaft 200 is configured not to rotate about the longitudinal axis A-A with respect to the second steering shaft bearing 516.

For example FIG. 9b comprises the first elongate rib 804 is mounted on the first bearing element 518 and the second elongate rib 806 is mounted on the second bearing element 520. The first and second elongate grooves 800, 802 are positioned on the steering shaft 200 to respectively engage the first elongate rib 804 and the second elongate rib 806.

FIG. 9c shows an alternative arrangement whereby each of the first bearing element 518, the second bearing element 520, the third bearing element 908, and the fourth bearing element 910 comprise an elongate rib. Similarly, the steering shaft 200 comprises reciprocal elongate grooves configured to engage the elongate ribs.

For the purposes of clarity the elongate ribs and elongate grooves in FIG. 9c have not been labelled. Whilst each of the first bearing element 518, the second bearing element 520, the third bearing element 908, and the fourth bearing element 910 comprise an elongate rib, in some examples only some or one of the first bearing element 518, the second bearing element 520, the third bearing element 908, and the fourth bearing element 910 comprises an elongate rib. Indeed a single elongate rib 804 in the second steering shaft bearing 516 configured to engage a single elongate groove 800 in the steering shaft 200 can prevent relative rotation of the steering shaft 200 with respect to the second steering shaft bearing 516.

FIG. 9d shows an alternative example whereby a channel protruding portion 920 of the steering shaft 200 is configured to slidably engage in the second elongate channel 906.

### EMF Baffle

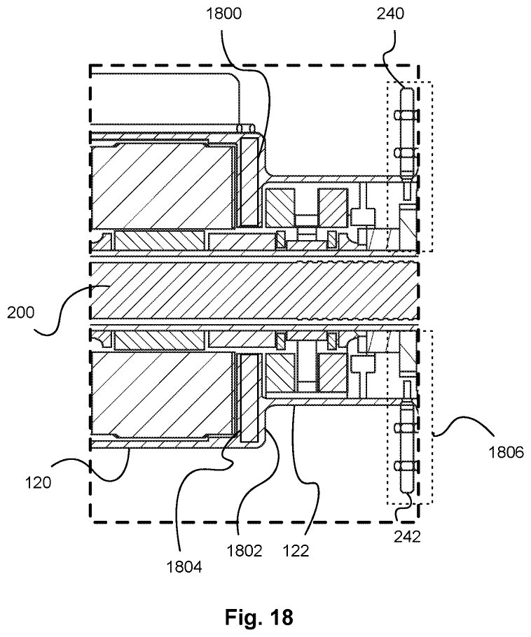

Another example will now be discussed in reference to FIG. 18. FIG. 18 shows a close up side cross-sectional view of the steering assembly 100 of the dotted box labelled B in FIG. 2.

During operation, the first and second motor 208, 210 will use a high current. This means that a large electromagnetic field (EMF) will be generated when the motor windings of first and/or the second motor 208, 210 are energised.

As mentioned above, one or more of the sensors e.g. the first, second and third rotational sensors 240, 242 are optionally hall-effect sensors. This means the proximity of the first, second and third rotational sensors 240, 242 to the motor housing portion 120 means that the first, second and third rotational sensors 240, 242 may also be exposed to the EMF generated by the energised first and second motors 208, 210. Since the hall-effect sensors detect magnetic fields, this means that there can be interference with the sensor signals.

In some examples, the motor housing portion 120 comprises an electromagnetic field (EMF) shield 1800. The EMF shield 1800 as shown in FIG. 18 is mounted between the motor housing portion 120 and the sensor housing portion 122. The EMF shield 1800 is configured to attenuate the electromagnetic field generated by the one or more motor windings.

The EMF shield 1800 comprises at least one intermediate wall 1802 of the main housing 102 positioned between the at least one rotational sensor 240 and the and the one or more motor windings of the first and second motor 208, 210.

The EMF shield 1800 is optionally a layer of EMF attenuating material that is mounted on the main housing 102. The EMF shield 1800 can be sandwiched between the motor housing portion 120 and the sensor housing portion 122. Alternatively, or additionally, the EMF shield 1800 comprises an intermediate wall 1802 between the motor housing portion 120 and the sensor housing portion 122.

The intermediate wall 1802 comprises an EMF shield recess 1804 for receiving the EMF shield 1800 e.g. a disc layer of an EMF attenuating material. The EMF shield 1800 comprises a central hole so that the rotor carrier sleeve 216 and the steering shaft 200 can pass through the central hole.

In some examples, the EMF shield 1800 comprises one or more layers of an EMF attenuating material mounted to the main housing 102. In some examples, the EMF shield 1800 comprises a plurality of different layers, each layer tuned to attenuate a different range of EMF frequencies.

In some examples, the EMF shield 1800 comprises an EMF attenuating material is one or more of a wire mesh material, an EMF shielding fabric, metal foam, a metal screen, a metal sheet.

Another example will now be discussed in reference to FIG. 12. FIG. 12 shows the screw actuator housing portion 1202 positioned between the motor housing portion 1204 and the sensor housing portion 1200. Accordingly, the EMF shield 1800 comprises one or more components of the steering assembly 100. That is, the EMF shield 1800 comprises the screw actuator 228 and the screw actuator housing portion 1202.

In another example the EMF shield 1800 optionally alternatively or additionally comprises a wire mesh envelope 1806 configured to surround the at least one rotational sensor 240, 242. This means that the EMF shield 1800 can also comprise a faraday cage around the first and second rotational sensors 240, 242 which can attenuate the EMF emitted from the first and second motors 208, 210. The EMF shield 1800 can comprise the layer of EMF attenuating material mounted on the motor housing portion 120 and/or the wire mesh envelope 1806.

### Cross Centre Sensor with Motor Rotation to Determine Position

In order to increase the sensor redundancy of the steering assembly 100, additional alternatives will now be discussed for the steering assembly 100 to determine the linear displacement of the steering shaft 200 in reference to FIGS. 3, 4, 14, 15, 16 and 17.

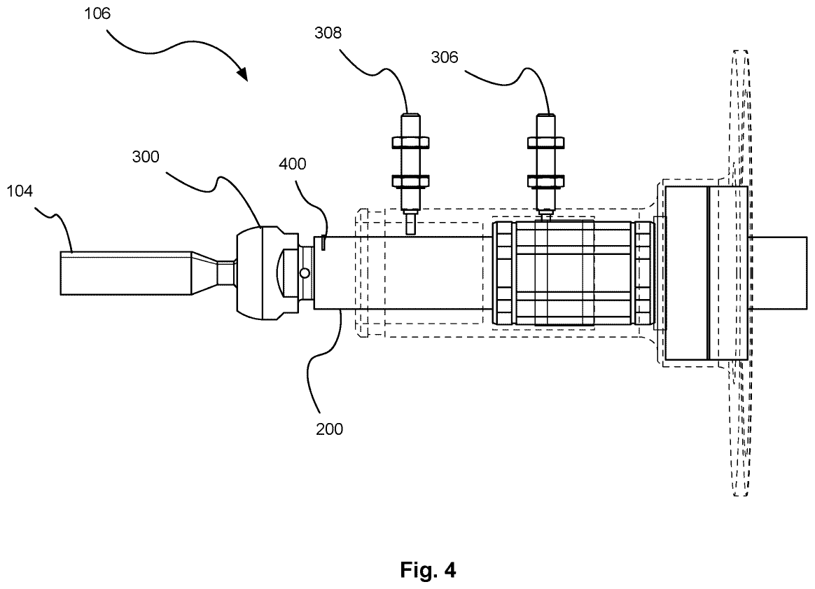

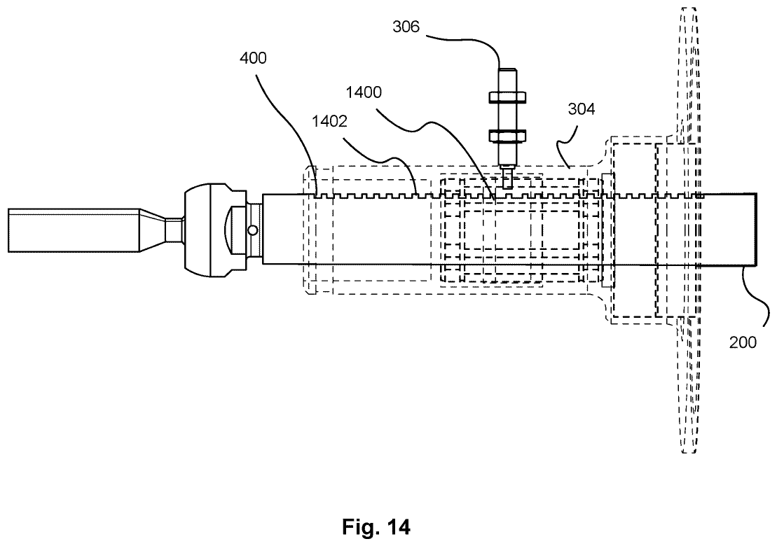

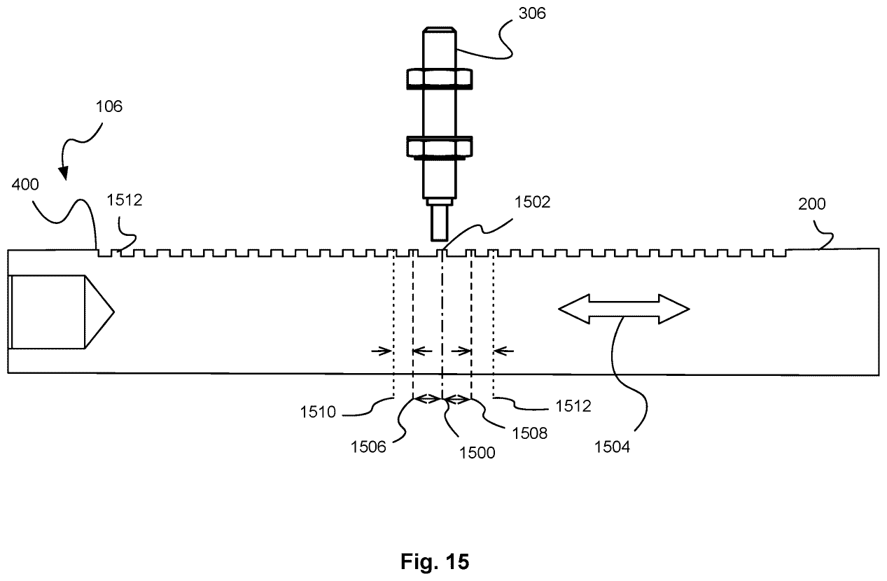

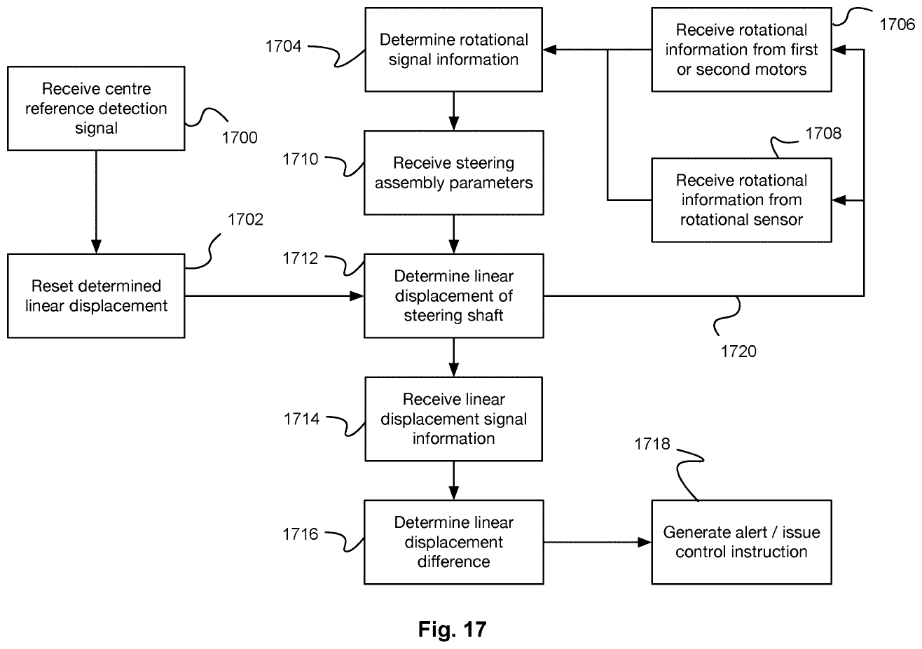

FIG. 3 shows a partial perspective view of the steering assembly 100 at the first steering assembly end 106. FIG. 4 shows a cross-sectional side view of part of the steering assembly 100 at the first steering assembly end 106. FIG. 14 shows another cross-sectional side view of part of the steering assembly 100 at the first steering assembly end 106. FIG. 15 shows a close up cross-sectional side view of part of the steering assembly 100. FIG. 16 shows a schematic representation of the steering assembly 100. FIG. 17 shows a flow diagram of operation of the steering assembly 100.

As shown in FIG. 3 the first steering assembly end 106 of the main housing 102 comprises a cross centre sensor 306 and an end position sensor 308. The cross centre sensor 306 and the end position sensor 308 are mounted in the first housing sleeve portion 304. The end position sensor 308 will be discussed in more detail below.

In some examples, for example as shown in FIG. 14, the cross centre sensor 306 is also the end position sensor 308. In this way, the cross centre sensor 306 as shown in FIG. 14 is a multifunction sensor and is configured to detect both the centre and end of the steering shaft 200. The end position sensor 308 functionality of the cross centre sensor 306 will be discussed below together with the end position sensor 308.

The cross centre sensor 306 will be described in more detail in FIG. 3. FIG. 3 shows that the first steering shaft bearing 302 comprises an elongate channel 310. In some examples, this comprises a similar construction to the second steering shaft bearing 516 as previously discussed. The first steering shaft bearing 302 can comprise a unitary construction or may comprise a plurality of bearing parts as discussed in reference to FIGS. 9a, 9b. 9c and 9d. Similar to the second steering shaft bearing 516, the elongate channel 310 in the first steering shaft bearing 302 allows the access to the steering shaft 200 for the cross centre sensor 306.

If there is a failure in the rotational sensor 240 and/or the linear displacement sensor 502, then the first and second ECUs 202, 204 need to determine the position of the steering shaft 200 in order to remain fail-operational. In some examples, the cross centre sensor 306 is configured to generate a sensor signal based on different input from the steering shaft 200. This increases the sensor redundancy of the steering assembly 100.

It is known to detect a centre reference point on steering systems. However, a problem with known steering systems is that in the event of a power loss, additional sensors are needed to determine the angle of the wheels/linear position of the steering shaft 200. In other words, the centre reference system is suitable for use with a driver and a vehicle, but not when the vehicle is autonomous. This means known steering systems using centre reference systems are at best fail safe and often need user input.

FIGS. 3, 4, 14, 15, 16 and 17 show examples whereby the steering assembly 100 comprises a cross centre sensor 306 configured to provide a sensor signal for use in a fail-operational steering assembly 100.

FIG. 15 shows a schematic representation of the cross centre sensor 306 positioned about the steering shaft 200. The cross centre sensor 306 is configured to detect a centre reference target 1500. The centre reference target 1500 in FIG. 15 is a projecting tooth 1502 from the steering shaft 200 which is aligned with the centre reference target 1500. The centre reference target 1500 corresponds to a centre reference point of the steering shaft 200. The centre reference point corresponds to the position of the steering shaft 200 with respect to the main housing 102 whereby the steering shaft 200 is centrally aligned to a geometric centre position of the steering shaft 200 with respect to the roller screw 230. That is the wheels of the vehicle are straight and not turned. As shown in FIG. 3, the cross centre sensor 306 is mounted on the first housing sleeve portion 304 at the first steering assembly end 106 of the main housing 102.

The cross centre sensor 306 is not positioned above the centre of the steering shaft 200. In some less preferred examples, the cross centre sensor 306 is mounted above the centre of the steering shaft 200. However, in more preferred examples, the cross centre sensor 306 is mounted away from the centre which provides more space for the other components of the steering assembly 100. This means that the heavier components of the steering assembly 100 such as the first and second motor 208, 210 are mounted in the centre of the steering assembly 100. This helps the stability of the vehicle in which the steering assembly 100 is mounted.

The cross centre sensor 306 is configured to generate a shaft centre signal when the centre reference target 1500 moves past the cross centre sensor 306. In some examples, the centre reference target 1500 is a magnet, a reference notch or recess in the steering shaft 200, or a projecting peg from the steering shaft 200. In some examples, the cross centre sensor 306 is a hall-effect sensor configured to detect e.g. the magnet, the reference notch or recess in the steering shaft 200, or the projecting peg from the steering shaft 200.

Whilst the examples as shown in FIGS. 3, 4, 14, 15, 16 and 17 show a hall-effect sensor, in other examples the cross centre sensor 306 can be any other suitable sensor. For example, the cross centre sensor 306 can be an optical sensor configured to detect a centre reference indication mark on the steering shaft 200. In some other examples, the centre reference target 1500 comprises a projecting finger (not shown) and the cross centre sensor 306 is a mechanical switch, a pressure sensor or a force sensor which is configured to generate a shaft centre signal e.g. actuate the mechanical switch when the projecting finger moves past the centre reference target 1500.

Another example of the cross centre sensor 306 is shown in FIGS. 14 and 15. The cross centre sensor 306 as shown in FIGS. 14 and 15 is similar to the linear displacement sensor 1300 as shown in FIG. 13. Similarly, the cross centre sensor 306 is configured to detect a plurality of reference notches 1400 on the first side 506 of the steering shaft 200.

The plurality of reference notches 1400 forms a linear toothed pattern 1402 in the first side 506 of the steering shaft 200. As each reference notch 1304 passes the cross centre sensor 306, the cross centre sensor 306 is configured to generate the centre shaft signal and send the centre shaft signal to the first or second ECU 202, 204.

In some examples, the cross centre sensor 306 is configured to vary a generated signal in dependence the position of the cross centre sensor 306 with respect to the linear tooth pattern 1402. For example, the spacing and size of the notches vary along the length of the linear tooth pattern 1402.

The linear tooth pattern 1402 comprises a different pattern immediately about the centre reference target 1500. The linear tooth pattern 1402 comprises primary adjacent reference targets 1506, 1508 which are positioned immediately either side of the centre reference target 1500. The distance between the primary adjacent reference targets 1506, 1508 and the centre reference target 1500 is larger than the spacing between other targets 1510, 1512. This means that the centre reference target 1500 is configured to generate a unique shaft centre signal in dependence of the steering shaft 200 position with respect to the main housing 102 near the centre reference target 1500. In some examples, the first or second ECUs 202, 204 are configured to determine that the difference in the spacing and size of the notches in the linear tooth pattern 1402 from the received sensor signal with an additional speed signal. The speed signal can be determined from the at least one rotational sensor 240 to determine the rotor carrier sleeve 216 position.

Accordingly, the cross centre sensor 306 is configured to generate a shaft centre signal when the centre reference target 1500 moves in either direction along the longitudinal axis A-A as shown by arrow 1504 as shown in step 1700 in FIG. 17. The first or second ECU 202, 204 receives the shaft centre signal indicating that the steering shaft 200 is centrally aligned or at least was centrally aligned at the time the signal was generated by the cross centre sensor 306.

The first or second ECU 202, 204 then determines that the linear displacement of the steering shaft 200 is zero when receiving the shaft centre signal as shown in step 1702. This means that the first or second ECU 202, 204 knows with certainty that the steering shaft 200 is centrally aligned.

At the same time the first or second ECU 202, 204 is configured to determine rotational signal information as shown in step 1704. Accordingly, the first or second ECU 202, 204 determines the rotational displacement of one or more rotational components of the steering assembly 100.

The first or second ECU 202, 204 may optionally receive rotational information from the first or second motors 208, 210 as shown in step 1706. For example, the first and second motors 208, 210 comprise data connections to the first or second ECUs 202, 204 and the status information of the first and second motors 208, 210 is received at the first or second ECUs 202, 204. Additionally or alternatively, the first or second ECUs 202, 204 receive rotational information from the at least one rotational sensor 240 as shown in step 1708. The at least one rotational sensor 240 has been previously discussed.

In some other examples, the first or second ECU 202, 204 do not receive rotational information from the first and second motors 208, 210 or the at least one rotational sensor 240. Instead, the first or second ECUs 202, 204 determine the rotational information of the first and second motors 208, 210 based on control instructions sent to the first and second motors 208, 210 in step 1704. In this way steps 1706, 1708 are optional.

The first ECU 202 or second ECU 204 then receives steering assembly parameters as shown in step 1710. The receiving of the steering assembly parameters can comprise retrieving parameters of the steering assembly from memory. For example, the steering assembly parameters are stored in a lookup table in memory. The steering assembly parameters are the gearing factor of the screw actuator 228. The gearing factor of the screw actuator 228 determines how far the steering shaft 200 moves with respect to the main housing 102 for every complete revolution of the first or second motor 208, 210.

The first ECU 202 or second ECU 204 determines the linear displacement of the steering shaft 200 based on the steering assembly parameters and the determined rotational signal information. For example, the first ECU 202 or second ECU 204 multiples the number of revolutions of the first or second motor 208, 210 and the gearing factor to determine the linear displacement of the steering shaft 200.

In this way, the first ECU 202 or the second ECU 204 can determine the linear displacement of the steering shaft 200 in the scenario if there is fault or failure of the other sensors e.g. the at least one rotational sensor 240 and/or the linear displacement sensor 502.

The first ECU 202 or the second ECU 204 keeps monitoring and determining the linear displacement of the steering shaft 200 as indicated by the arrow 1720. As mentioned above, periodically the first ECU 202 or second ECU 204 receives the shaft centre signal from the cross centre sensor 306 in step 1700.

When the first ECU 202 or the second ECU 204 receives shaft centre signal, the determined linear displacement is reset to zero as shown in step 1702. The first ECU 202 or the second ECU 204 resets the determined linear displacement irrespective of the current determined linear displacement. This means that errors or drift in the determined linear displacement are corrected every time the centre reference target 1500 moves past the cross centre sensor 306. Since most of the time the steering assembly 100 will be operated with the steering shaft 200 centrally aligned, the determined linear displacement will be frequently reset to zero and calculation errors minimised.

Optionally, in some examples, the first ECU 202 or the second ECU 204 receives linear displacement signal information from the linear displacement sensor 502 as shown in step 1714. The linear displacement sensor 502 has been discussed previously. The first ECU 202 or the second ECU 204 then compares the linear displacement signal information from the linear displacement sensor 502 with the determined linear displacement of the steering shaft 200 as shown in step 1716. If the first ECU 202 or the second ECU 204 determines that the difference is greater than a threshold tolerance e.g. more than 0.05%, 0.1%, 0.2%, 0.3%, 0.4% 0.5%, 0.6%, 0.7%, 0.8%, 0.9%, 1.0% etc. then the first ECU 202 or the second ECU 204 can issue an alert in step 1718 that there is an error with the either the cross centre sensor 306 or the linear displacement sensor 502. The alert can be issued to the VCU 1600.

### End Position Sensor

As mentioned above, the steering assembly 100 also comprises an end position sensor 308 which will now be discussed in more detail with reference to FIGS. 3, 4, 14 and 15.

Similar to the cross centre sensor 306, the end position sensor 308 is configured to detect movement of the steering shaft 200. In particular, the end position sensor 308 is configured to detect relative movement of the first tie rod coupling 300 or a steering shaft end 312 with respect to the main housing 102. This means that the end position sensor 308 is configured to detect end of travel of the steering shaft 200.

The end position sensor 308 is configured to send a shaft end proximity signal to the first or second ECU 202, 204 before the steering shaft end 312 of the steering shaft 200 at the first tie rod coupling 300 is near the main housing 102 e.g. the first housing sleeve portion 304. This stops a metal on metal clash and protects the structure of the steering assembly 100 and the ball joint of the first tie rod coupling 300, whilst eliminating clash or clonk noises and vibrations that may be felt by passengers in the vehicle.

The end position sensor 308 is configured to generate a shaft end proximity signal when the end reference target 400 (best shown in FIG. 4) moves past the end position sensor 308.

In some examples, the end reference target 400 is a magnet, a reference notch or recess in the steering shaft 200, or a projecting peg from the steering shaft 200. In some examples, the end reference target 400 is a hall-effect sensor configured to detect e.g. the magnet, the reference notch or recess in the steering shaft 200, or the projecting peg from the steering shaft 200.

In some examples, the end position sensor 308 is configured to detect the profile of the steering shaft end 312 of the steering shaft 200 as it approaches the end position sensor 308. The end position sensor 308 is configured to generate a shaft end proximity signal before the first tie rod coupling 300 impacts the main housing 102 e.g. the first housing sleeve portion 304. When the first or second ECU 202, 204 receives the shaft end proximity signal, the first or second ECU 202, 204 is configured to issue a control instruction to stop or reverse the direction of travel of the steering shaft 200. This avoids the impact between the first tie rod coupling 300 on the main housing 102.

Whilst the examples as shown in FIGS. 3, 4, 14, and 15 show a hall-effect sensor, in other examples the end position sensor 308 can be any other suitable sensor. For example, the end position sensor 308 can be an optical sensor configured to detect a centre reference indication mark on the steering shaft 200. In some other examples, the end reference target 400 comprises a projecting finger (not shown) and the cross centre sensor 306 is a mechanical switch, a pressure sensor or a force sensor which is configured to generate a shaft centre signal e.g. actuate the mechanical switch when the projecting finger moves past the end reference target 400.

FIGS. 3 and 4 show the end position sensor 308 mounted on the first steering assembly end 106 of the steering assembly 100. In some other examples, additionally or alternatively, the end position sensor 308 can be mounted on the second steering assembly end 110 of the steering assembly 100.

Another example of the end position sensor 308 is shown in FIGS. 14 and 15. As mentioned above, the end position sensor 308 is also the cross centre sensor 306. The cross centre sensor 306 as shown in FIGS. 14 and 15 has been discussed above. In this example the cross centre sensor 306 is configured to detect both the end reference target 400 and the centre reference target 1500. The cross centre sensor 306 being configured to detect both the end reference target 400 and the centre reference target 1500 may reduce the sensor redundancy of the steering assembly 100, however an identical sensor can be mounted on the second steering assembly end 110 of the steering assembly 100.

The first or second ECUs 202, 204 are configured to receive both the shaft centre signal and the shaft end proximity signal from the cross centre sensor 306. In some examples, first or second ECUs 202, 204 are configured to differentiate between the shaft centre signal and the shaft end proximity signal corresponding respectively to the end reference target 400 and the centre reference target 1500. In some examples, the first or second ECUs 202, 204 are configured to determine that the shaft centre signal and the shaft end proximity signal are different. For example, the end reference target 400 and the centre reference target 1500 can comprise different cross-sectional shapes which results in the cross centre sensor 306 generating a different shaft centre signal and a shaft end proximity signal. In other examples, the first or second ECUs 202, 204 are configured to determine that the distances from the centre reference target 1500 and the other adjacent reference targets 1510, 1512 are different.

The linear tooth pattern 1402 may comprise a varied tooth size, tooth shape and separate along the length of the steering shaft 200. Indeed, the tooth size and tooth spacing can be unique for each position along the linear tooth pattern 1402. This means that the first or second ECUs 202, 204 can determine the position of the cross centre sensor 306 with respect to the steering shaft 200.

FIG. 16 shows the various sensors connected to the first and second ECUs 202, 204. Each of the rotational sensor 240, the end position sensor 308, the cross centre sensor 306, the shaft strain sensor 1602 and the linear displacement sensor 502 can be a plurality of separate sensors.

### First Set of Examples

Example 1. A steer-by-wire steering assembly comprising:
a housing;
a motor assembly having at least one rotor and at least one stator having a first motor winding and a second motor winding, the at least one stator being mounted to the housing;
at least one screw actuator operatively coupled to the at least one rotor;
a steering shaft connectable to at least one tie rod, the steering shaft comprising a threaded portion configured to engage with the at least one screw actuator and to move longitudinally with respect to the housing when the first motor winding and/or the second motor winding is actuated; and
at least one bearing mounted between the housing and the steering shaft wherein the bearing comprises at least one elongate channel configured to receive a projecting component or portion of the steering shaft.

Example 2. A steer-by-wire steering assembly according to example 1 wherein the at least one bearing comprises a C-shaped cross-sectional open profile.

Example 3. A steer-by-wire steering assembly according to examples 1 or 2 wherein the at least one bearing comprises a first bearing element configured to engage a first side of the steering shaft and a second bearing element configured to engage a second side of the steering shaft.

Example 4. A steer-by-wire steering assembly according to example 3 wherein the at least one bearing comprises a first channel configured to receive a first projecting component or a first portion of the steering shaft and a second channel configured to receive a second projecting component or a second portion of the steering shaft.

Example 5. A steer-by-wire steering assembly according to any of the preceding examples wherein the steering shaft is configured to not rotate about a longitudinal axis of the steering shaft with respect to the at least one bearing.

Example 6. A steer-by-wire steering assembly according to example 5 wherein the steering shaft comprises an elongate groove slidably engageable with an elongate rib mounted on an inner surface of the at least one bearing.

Example 7. A steer-by-wire steering assembly according to any of the preceding examples wherein the elongate channel extends in a direction which is parallel with a longitudinal axis of the steering shaft.

Example 8. A steer-by-wire steering assembly according to any of the preceding examples wherein the elongate channel is an open channel.

Example 9. A steer-by-wire steering assembly according to any of the preceding examples wherein the steer-by-wire steering assembly comprises a linear displacement sensor having a first sensor portion mounted in the at least one elongate channel on the steering shaft and a second sensor portion mounted to the housing configured to project into the at least one elongate channel.

Example 10. A steer-by-wire steering assembly according to any of the preceding examples wherein the at least one bearing is mounted at a first end of the housing and the at least one bearing is configured to engage a first end of the steering shaft.

Example 11. A steer-by-wire steering assembly according to any of the preceding examples wherein the at least one screw actuator is a roller screw actuator comprising a plurality of planetary roller screws operatively coupled to the at least one rotor.

Example 12. A steer-by-wire steering assembly according to any of the preceding examples wherein the steer-by-wire steering assembly comprises a rotor carrier sleeve rotatably mounted to the housing and coupled between the at least one rotor and the at least one screw actuator.

Example 13. A steer-by-wire steering assembly according to example 12 wherein the steering shaft is mounted inside the rotor carrier sleeve.

Example 14. A steer-by-wire steering assembly according to any of the preceding examples wherein the steer-by-wire steering assembly comprises a first electronic control unit configured to send one or more control signals to the first motor and/or the second motor and a second electronic control unit configured to send one or more control signals to the second motor and/or the first motor.

Example 15. A steer-by-wire steering assembly according to example 14 wherein the first electronic control unit and the second electronic control unit are configured to receive one or more control signals from a vehicle control unit.

Example 16. A steer-by-wire steering assembly according to any of the preceding examples wherein the at least one bearing is a first bearing mounted at a first end of the housing and the first bearing is configured to engage a first end of the steering shaft and a second bearing mounted at a second end of the housing and second bearing is configured to engage a second end of the steering shaft.

Example 17. A steer-by-wire steering assembly according to any of the preceding examples wherein the motor assembly comprises a first motor having a first rotor and a first stator having the first motor winding and a second motor having a second rotor and a second stator having the second motor winding, wherein the first stator and the second stator are mounted to the housing.

### Second Set of Examples

Example 1. A steer-by-wire steering assembly comprising:
a housing;
a motor assembly having at least one rotor and at least one stator having a first motor winding and a second motor winding, the at least one stator being mounted to the housing;
a screw actuator operatively coupled to the at least one rotor;
a steering shaft connectable to at least one tie rod, the steering shaft comprising a threaded portion configured to engage with the screw actuator and to move longitudinally with respect to the housing when the first motor winding and/or the second motor winding is actuated; and
a linear displacement sensor positioned near an end of the steering shaft, the linear displacement sensor configured to generate a signal in dependence of detecting linear movement of the steering shaft with respect to the housing.

Example 2. A steer-by-wire steering assembly according to example 1 wherein the at least one linear displacement sensor is mounted adjacent to the tie rod.

Example 3. A steer-by-wire steering assembly according to any of the preceding examples wherein the at least one linear displacement sensor is one or more of an optical sensor, a linear resistive sensor, linear voltage displacement transducer, linear potentiometer, a potentiometric linear transducer, or a hall-effect sensor.

Example 4. A steer-by-wire steering assembly according to any of the preceding examples wherein the at least one linear displacement sensor comprises a first linear displacement sensor portion mounted on the steering shaft and a second linear displacement sensor portion mounted to the housing.

Example 5. A steer-by-wire steering assembly according to example 4 wherein the second linear displacement sensor portion is an optical sensor mounted to the housing and the first linear displacement sensor portion are a plurality of reference indicators on the steering shaft.

Example 6. A steer-by-wire steering assembly according to example 4 wherein the second linear displacement sensor portion is a hall-effect sensor mounted to the housing and the first linear displacement sensor portion is a linear tooth pattern mounted to the steering shaft.

Example 7. A steer-by-wire steering assembly according to example 6 wherein the linear tooth pattern varies as a function of distance along the steering shaft and the hall-effect sensor is configured to vary a generated signal in dependence the position of the hall-effect sensor with respect to the linear tooth pattern.

Example 8. A steer-by-wire steering assembly according to any of the preceding examples wherein the at least one screw actuator is a roller screw actuator comprising a plurality of planetary roller screws operatively coupled to the at least one rotor.

Example 9. A steer-by-wire steering assembly according to any of the preceding examples wherein the steer-by-wire steering assembly comprises a rotor carrier sleeve rotatably mounted to the housing and coupled between the at least one rotor and the at least one screw actuator.

Example 10. A steer-by-wire steering assembly according to example 9 wherein the steering shaft is mounted inside the rotor carrier sleeve.

Example 11. A steer-by-wire steering assembly according to any of the preceding examples wherein the steer-by-wire steering assembly comprises a first electronic control unit configured to send one or more control signals to the first motor and/or the second motor and a second electronic control unit configured to send one or more control signals to the second motor and/or the first motor.

Example 12. A steer-by-wire steering assembly according to example 11 wherein the first electronic control unit and the second electronic control unit are configured to receive one or more control signals from a vehicle control unit.

Example 13. A steer-by-wire steering assembly according to any of the preceding examples wherein the motor assembly comprises a first motor having a first rotor and a first stator having the first motor winding and a second motor having a second rotor and a second stator having the second motor winding, wherein the first stator and the second stator are mounted to the housing.

Third set of examples

Example 1. A steer-by-wire steering assembly comprising:

a housing;

at least one electronic control unit;

a motor assembly having at least one rotor and at least one stator having a first motor winding and a second motor winding, the at least one stator being mounted to the housing and the at least one electronic control unit having at least one data connection with the motor assembly and the at least one electronic control unit is configured to control the first motor winding and the second motor winding; a screw actuator operatively coupled to the at least one rotor; a steering shaft connectable to at least one tie rod, the steering shaft comprising a threaded portion configured to engage with the screw actuator and to move longitudinally with respect to the housing when the first motor winding or the second motor winding is actuated; and a first displacement sensor mounted to the housing configured to send a signal to the at least one electronic control unit in dependence of detecting a centre reference target of the steering shaft;

wherein the electronic control unit is configured to determine a displacement of the steering shaft with respect to the housing in dependence of the received signal from the first displacement sensor and rotational information of the at least one rotor.

Example 2. A steer-by-wire steering assembly according to example 1 wherein the electronic control unit is configured to reset the determined displacement to zero when the centre reference target is detected.

Example 3. A steer-by-wire steering assembly according to examples 1 or 2 wherein the rotational information is one or more signals received from the motor assembly comprising rotational information of the at least one rotor.

Example 4. A steer-by-wire steering assembly according to any of the preceding examples wherein the rotational information is one or more signals received from at least one rotational sensor mounted to the housing configured to send a signal in dependence of detecting relative rotational displacement of the at least one rotor with respect to the housing.

Example 5. A steer-by-wire steering assembly according to any of the preceding examples wherein the rotational information is determined from one or more control signals issued to the motor assembly from the electronic control unit.

Example 6. A steer-by-wire steering assembly according to any of examples 3 to 5 wherein the electronic control unit is configured to determine the displacement based on the rotational information and a gearing parameter of the screw actuator.

Example 7. A steer-by-wire steering assembly according to any of the preceding examples wherein the electronic control unit is configured to compare the determined displacement with a signal received from a second displacement sensor.

Example 8. A steer-by-wire steering assembly according to example 7 wherein the electronic control unit is configured to issue an alert signal when the electronic control unit determines that the determined displacement deviates from a predetermined tolerance of a second displacement determined from the signal received from a second displacement sensor.

Example 9. A steer-by-wire steering assembly according to any of the preceding examples wherein a first displacement sensor is a hall-effect sensor.

Example 10. A steer-by-wire steering assembly according to 9 wherein the centre reference target is a centre reference feature on the steering shaft and the first displacement sensor is configured to detect the centre reference feature.

Example 11. A steer-by-wire steering assembly according to 10 wherein the centre reference feature is a notch, recess, raised profile, or projecting tooth on the steering shaft.

Example 12. A steer-by-wire steering assembly according to 9 or 10 wherein the centre reference target is a centre reference magnet in the steering shaft and the first displacement sensor is configured to detect the centre reference magnet.

Example 13. A steer-by-wire steering assembly according to any of the preceding examples wherein a first displacement sensor is an optical sensor configured to detect a reference indicator on the surface of the steering shaft.

Example 14. A steer-by-wire steering assembly according to any of the preceding examples wherein a first displacement sensor is a mechanical switch configured to detect a raised peg mounted on the surface of the steering shaft.

Example 15. A steer-by-wire steering assembly according to any of the preceding examples wherein the at least one screw actuator is a roller screw actuator comprising a plurality of planetary roller screws operatively coupled to the at least one rotor.

Example 16. A steer-by-wire steering assembly according to any of the preceding examples wherein the steer-by-wire steering assembly comprises a rotor carrier sleeve rotatably mounted to the housing and coupled between the at least one first rotor and the at least one screw actuator.

Example 17. A steer-by-wire steering assembly according to example 16 wherein the steering shaft is mounted inside the rotor carrier sleeve.

Example 18. A steer-by-wire steering assembly according to any of the preceding examples wherein the at least one electronic control unit is configured to receive one or more control signals from a vehicle control unit.

Example 19. A steer-by-wire steering assembly according to any of the preceding examples wherein the motor assembly comprises a first motor having a first rotor and a first stator having the first motor winding and a second motor having a second rotor and a second stator having the second motor winding, wherein the first stator and the second stator are mounted to the housing.

Example 20. A method of controlling a steer-by-wire steering assembly having a housing; at least one electronic control unit; a motor assembly having at least one rotor and at least one stator having a first motor winding and second motor winding, the at least one stator being mounted to the housing and the at least one electronic control having at least one data connection with the motor assembly and the at least one electronic control is configured to control the first motor winding and the second motor winding; a screw actuator operatively coupled to the at least one rotor; a steering shaft connectable to at least one tie rod, the steering shaft comprising a threaded portion configured to engage with the screw actuator and to move longitudinally with respect to the housing when the first motor winding or the second motor winding is actuated; the method comprising:
detecting a centre reference target of the steering shaft with a first displacement sensor mounted to the housing;
sending signal from a first displacement sensor mounted to the housing to the at least one electronic control unit;
determining a displacement of the steering shaft with respect to the housing in dependence of the received signal from the first displacement sensor and rotational information of the at least one rotor.

In another example, two or more examples are combined. Features of one example can be combined with features of other examples.

Examples of the present disclosure have been discussed with particular reference to the examples illustrated. However it will be appreciated that variations and modifications may be made to the examples described within the scope of the disclosure.

1. A steer-by-wire steering assembly comprising:
a housing;
a motor assembly having at least one rotor and at least one stator having a first motor winding and a second motor winding, the at least one stator being mounted to the housing;
at least one screw actuator operatively coupled to the at least one rotor;
a steering shaft connectable to at least one tie rod, the steering shaft including a threaded portion configured to engage with the screw actuator and to move longitudinally with respect to the housing when at least one of the first motor winding or the second motor winding is actuated; and
at least one rotational sensor mounted on the housing adjacent to one or more rotatable components, the at least one rotational sensor being configured to generate a signal in dependence on detecting rotational movement of the rotatable components with respect to the housing; and
at least one linear displacement sensor mounted to an end of the steering shaft, the linear displacement sensor being configured to generate a signal in dependence of detecting linear movement of the steering shaft with respect to the housing.

2. The steer-by-wire steering assembly according to claim 1, wherein the at least one linear displacement sensor is mounted adjacent to the tie rod.

3. The steer-by-wire steering assembly according to claim 1, wherein the one or more rotatable components is the at least one rotor.

4. The steer-by-wire steering assembly according claim 3, further comprising:
a rotor carrier sleeve rotatably mounted to the housing and coupled between the at least one rotor and the at least one screw actuator.

5. The steer-by-wire steering assembly according to claim 1, wherein the at least one rotational sensor is a plurality of rotational sensors mounted circumferentially about the housing.

6. The steer-by-wire steering assembly according to claim 4, wherein the at least one rotational sensor is configured to detect rotational movement of the rotor carrier sleeve with respect to the housing.

7. The steer-by-wire steering assembly according to claim 6, wherein a reluctor ring is mounted to the rotor carrier sleeve.

8. The steer-by-wire steering assembly according to claim 1, wherein the at least one rotational sensor is a hall-effect sensor.

9. The steer-by-wire steering assembly according to claim 1, wherein the at least one linear displacement sensor is one or more of an optical sensor, a linear resistive sensor, linear voltage displacement transducer, linear potentiometer, a potentiometric linear transducer, or a hall-effect sensor.

10. The steer-by-wire steering assembly according to claim 1, wherein the at least one linear displacement sensor comprises:
a first linear displacement sensor portion mounted on the steering shaft; and
a second linear displacement sensor portion mounted to the housing.

11. The steer-by-wire steering assembly according to claim 10, wherein the second linear displacement sensor portion is a hall-effect sensor mounted to the housing and the first linear displacement sensor portion is a linear tooth pattern mounted to the steering shaft.

12. The steer-by-wire steering assembly according to claim 11, wherein the linear tooth pattern varies as a function of distance along the steering shaft and the hall-effect sensor is configured to vary a generated signal in dependence of the position of the hall-effect sensor with respect to the linear tooth pattern.

13. The steer-by-wire steering assembly according to claim 1, wherein the at least one screw actuator is a roller screw actuator comprising a plurality of planetary roller screws operatively coupled to the at least one rotor.

14. The steer-by-wire steering assembly according to claim 1, wherein the steer-by-wire steering assembly comprises:
a first electronic control unit configured to send one or more control signals to at least one of the first motor or the second motor; and
a second electronic control unit configured to send one or more control signals to at least one of the second motor or the first motor.

15. The steer-by-wire steering assembly according to claim 14, wherein the first electronic control unit and the second electronic control unit are configured to receive one or more control signals from a vehicle control unit.

16. The steer-by-wire steering assembly according to claim 1, wherein the motor assembly comprises:
a first motor having a first rotor and a first stator having the first motor winding; and
a second motor having a second rotor and a second stator having the second motor winding, wherein
the first stator and the second stator are mounted to the housing.
